(19) United States
(12) Patent Application Publication
(10) Pub. No.: US 2025/0025780 A1
(43) Pub. Date: Jan. 23, 2025

(54) STORAGE MEDIUM, INFORMATION PROCESSING SYSTEM, INFORMATION PROCESSING APPARATUS AND INFORMATION PROCESSING METHOD

(71) Applicant: NINTENDO CO., LTD., Kyoto (JP)

(72) Inventors: Haruyuki OHASHI, Tokyo (JP); Takafumi OGIHARA, Tokyo (JP); Akira OTANI, Kyoto (JP); Tomoki FUKUSHIMA, Kyoto (JP)

(21) Appl. No.: 18/678,771

(22) Filed: May 30, 2024

(30) Foreign Application Priority Data
Jul. 21, 2023 (JP) 2023-119025

(51) Int. Cl. A63F 13/44; A63F 13/56

(52) U.S. Cl. CPC A63F 13/44; A63F 13/56; A63F 2300/638

(57) ABSTRACT

A non-limiting example game apparatus includes a processor, and based on an operation input of a user, the processor controls a player object in a first virtual space, makes the player object move within a base island object, or executes a predetermined event that is set to the base island object. Moreover, the base island object and a drift island object are moved automatically on any one ocean current out of a plurality of ocean currents provided in a world map of the second virtual space according to elapse of time. When satisfying a first positional condition related to the position of the base island object and the drift island object in the second virtual space, the drift island object that the first positional condition is satisfied is arranged in the first virtual space. Moreover, in the first virtual space, the player object is moved to the drift island object from the base island object, and the player object executes a predetermined event that is set to the drift island object.

### CROSS REFERENCE OF RELATED APPLICATION

This application claims a priority to Japanese Patent Application No. 2023-119025 filed on Jul. 21, 2023, and the entire contents of which are incorporated herein by reference.

### FIELD

This application describes a storage medium, an information processing system, an information processing apparatus and an information processing method, which executes an event in a virtual space that is different from a world map while moving on the world map.

### BACKGROUND AND SUMMARY

In a conventional game apparatus, a player character is moved between a town to a town on a world map by operating a controller. When the player character is moved between towns on the world map, the date of a virtual concept in a game is updated. A local map is formed in each town, and by operating a controller in the town, the player character is moved on the local map. If a predetermined condition is satisfied as the player character is being moved in the world map and the local route map, an event according to a battle occurs.

However, in the above-described game apparatuses, when the player character is being moved on a world map between a town and a town, the player cannot perform anything other than the moving on the world map. Moreover, if the player character moved to the town from the town on the world map, the player character is moved by an operation of a controller on the local map of the town, and if a battle is started, the battle with an enemy character is performed on a battle map while receiving an instruction of the player from the controller. Therefore, when the player character is being moved on the local map, or when it is during the battle on the battle map, the player cannot move the player character on the world map.

This application discloses a novel storage medium, information processing system, information processing apparatus and information processing method.

Moreover, this application describes a storage medium, information processing system, information processing apparatus and information processing method, capable of executing an event in a virtual space while moving in a different virtual space.

A first embodiment non-transitory computer-readable storage medium having stored with an information processing program executable by a computer of an information processing apparatus, wherein the information processing program causes one or more processors of the computer to execute: controlling, based on an operation input by a user, a character object associated with the user in a first virtual space; arranging a first object and a second object in a second virtual space different from the first virtual space; moving the first object automatically as elapse of time in the second virtual space; arranging a third object corresponding to the second object in the first virtual space when a first positional condition related to positions of the first object and the second object in the second virtual space is satisfied; and executing an event related to the third object if an event generation condition related to the third object is satisfied when the third object is arranged in the first virtual space.

According to the first embodiment, it is possible to execute an event in the first virtual space different form the second virtual space while moving in the second virtual space.

A second embodiment is the storage medium according to the first embodiment, wherein the information processing program causes one or more processors of the computer to execute moving the second object automatically as elapse of time.

According to the second embodiment, since the second object is also made to be moved automatically, complexity of the positional relationship in the second virtual space is increased, and therefore, it is possible to allow a wider selection of which third object related event to execute.

A third embodiment is the storage medium according to the first embodiment, wherein moving the first object on a predetermined moving route in the second virtual space.

A fourth embodiment is the storage medium according to the third embodiment, wherein the information processing program causes one or more processors of the computer to execute: setting a plurality of predetermined moving routes; and moving the first object on one predetermined moving route out of the plurality of predetermined moving routes.

A fifth embodiment is the storage medium according to the fourth embodiment, wherein the information processing program causes one or more processors of the computer to execute moving the first object from the predetermined moving route on which the first object is currently moving to a further predetermined moving route out of the plurality of predetermined moving routes.

A sixth embodiment is the storage medium according to the third embodiment, wherein the information processing program causes one or more processors of the computer to execute: setting the plurality of predetermined moving routes each of which is an annular shape; and moving the second object on one predetermined moving route out of the plurality of predetermined moving routes.

According to the sixth embodiment, the moving route is an annular shape, and since the first object and the second object respectively move in the same place repeatedly, even if the event related to the third object cannot be executed, it is sufficient to wait for a next opportunity.

A seventh embodiment is the storage medium according to the first embodiment, wherein the information processing program causes one or more processors of the computer to execute changing a moving speed of the first object when a speed change condition is satisfied.

According to the seventh embodiment, it is possible to shorten a time until the event related to the third object is executed by increasing the moving speed of the first object, and it is also possible to lengthen the time until the event related to the third object is executed by decreasing the moving speed of the first object.

An eighth embodiment is the storage medium according to the first embodiment, wherein moving the first object automatically regardless of an operation by the user.

According to the eighth embodiment, since the first object is moved automatically, it is only necessary to control the character object in the first virtual space, which improves convenience.

A ninth embodiment is the storage medium according to the first embodiment, wherein the information processing program causes one or more processors of the computer to execute restricting a movement of the first object while a priority event is executed in the first virtual space.

If the first object is moved while the priority event is executed, it is impossible to execute the event related to the third object; however, according to the ninth embodiment, since a movement of the first object is restricted while the priority event is executed, it is possible to prevent the opportunity of executing the event related to the third object from being lost.

A tenth embodiment is the storage medium according to the first embodiment, wherein the information processing program causes one or more processors of the computer to execute moving the third object automatically in the first virtual space.

An eleventh embodiment is the storage medium according to the tenth embodiment, wherein the information processing program causes one or more processors of the computer to execute moving the third object, when the third object and a fourth object corresponding to the first object pass each other in the first virtual space, on a right side or a left side of the fourth object according to a positional relationship between the first object and the second object in the second virtual space.

According to the eleventh embodiment, it is possible to move the third object in the first virtual space in correspondence to the positional relationship between the first object and the second object in the second virtual space.

A twelfth embodiment is the storage medium according to the tenth embodiment, wherein moving the third object in the first virtual space regardless of a position of the second object in the second virtual space.

A thirteenth embodiment is the storage medium according to the twelfth embodiment, wherein the information processing program causes one or more processors of the computer to execute determining a moving speed of the third object according to a positional relationship between the first object and the second object in the second virtual space.

According to the thirteenth embodiment, since the moving speed of the third object is determined according to the positional relationship between the first object and the second object, it is possible to move the third object in the first virtual space as if the third object is synchronized with the positional relationship between the first object and the second object. A fourteenth embodiment is the storage medium according to the first embodiment, wherein the information processing program causes one or more processors of the computer to execute performing, when arranging the third object in the first virtual space, a notification related to an arrangement of the third object.

According to the fourteenth embodiment, it is possible to know an arrangement of the third object in advance.

A fifteenth embodiment is the storage medium according to the first embodiment, wherein the information processing program causes one or more processors of the computer to execute eliminating the third object from the first virtual space when an elimination condition related to the third object is satisfied.

According to the fifteenth embodiment, it is possible to eliminate the third object when satisfying the elimination condition based on the moving speed that is determined according to the positional relationship between the first object and the second object in the second virtual space.

A sixteenth embodiment is the storage medium according to the fifteenth embodiment, wherein the information processing program causes one or more processors of the computer to execute eliminating the third object from the first virtual space even if the elimination condition is not satisfied when a positional relationship between the first object and the second object in the second virtual space satisfies a second positional condition.

According to the sixteenth embodiment, it is possible to eliminate the third object even if the elimination condition is not satisfied when satisfying the second positional condition that the first object and the second object are separated from each other by a predetermined distance or more in the second virtual space.

A seventeenth embodiment is the storage medium according to the first embodiment, wherein the information processing program causes one or more processors of the computer to execute arranging the third object in a predetermined position in the first virtual space regardless of a positional relationship between the first object and the second object in the second virtual space.

An eighteenth embodiment is the storage medium according to the first embodiment, wherein the information processing program causes one or more processors of the computer to execute generating the event that makes a scene transit to a relevant scene related to the third object.

A nineteenth embodiment is the storage medium according to the eighteenth embodiment, wherein the information processing program causes one or more processors of the computer to execute making the scene transitable to the relevant scene based on an operation input by a user regardless of a positional relationship between the first object and the second object in the second virtual space when a correspondence condition in the relevant scene is satisfied.

According to the nineteenth embodiment, when the correspondence condition in the relevant scene is satisfied, it is possible to transit the scene to the relevant scene freely.

A twentieth embodiment is the storage medium according to the claim first embodiment, wherein the information processing program causes one or more processors of the computer to execute executing the event in the first virtual space when an operation by the user is a designation operation with respect to the third object.

A twenty-first embodiment is the storage medium according to the first embodiment, wherein the information processing program causes one or more processors of the computer to execute arranging the second object in a plural number in the second virtual space; and corresponding each of different events to each of the second objects.

A twenty-second embodiment is the storage medium according to the first embodiment, wherein the information processing program causes one or more processors of the computer to execute outputting to a display an image that includes at least one of a first image corresponding to the first virtual space and a second image corresponding to the second virtual space.

A twenty-third embodiment is an information processing system comprising one or more processors, wherein the information processing system causes the one or more processors to execute: controlling, based on an operation input by a user, a character object associated with the user in a first virtual space; arranging a first object and a second object in a second virtual space different from the first virtual space; moving the first object automatically as elapse of time in the second virtual space; arranging a third object corresponding to the second object in the first virtual space when a first positional condition related to positions of the first object and the second object in the second virtual space is satisfied; and executing an event related to the third object if an event generation condition related to the third object is satisfied when the third object is arranged in the first virtual space.

A twenty-forth embodiment is an information processing apparatus comprising one or more processors, wherein the information processing apparatus causes the one or more processors to execute: controlling, based on an operation input by a user, a character object associated with the user in a first virtual space; arranging a first object and a second object in a second virtual space different from the first virtual space; moving the first object automatically as elapse of time in the second virtual space; arranging a third object corresponding to the second object in the first virtual space when a first positional condition related to positions of the first object and the second object in the second virtual space is satisfied; and executing an event related to the third object if an event generation condition related to the third object is satisfied when the third object is arranged in the first virtual space.

A twenty-fifth embodiment is an information processing method of an inform processing apparatus comprising one or more processors, wherein the information processing apparatus causes one or more processors to execute: controlling, based on an operation input by a user, a character object associated with the user in a first virtual space; arranging a first object and a second object in a second virtual space different from the first virtual space; moving the first object automatically as elapse of time in the second virtual space; arranging a third object corresponding to the second object in the first virtual space when a first positional condition related to positions of the first object and the second object in the second virtual space is satisfied; and executing an event related to the third object if an event generation condition related to the third object is satisfied when the third object is arranged in the first virtual space.

According to each of the twenty-third embodiment through the twenty-fifth embodiment, similar to the first embodiment, it is possible to execute the event in the first virtual space different from the second virtual space.

The features, aspects and advantages of the embodiment(s) will become more apparent from the following detailed description when taken in conjunction with the accompanying drawings.

### BRIEF DESCRIPTION OF THE DRAWINGS

FIG. 1 is a block diagram showing non-limiting example electric structure of a game apparatus.

FIG. 2 is a view showing a non-limiting example game screen of a base island scene displayed on the display device of the game apparatus shown in FIG. 1.

FIG. 3 is a view showing a non-limiting example marine chart screen displayed on the display device of the game apparatus shown in FIG. 1.

FIG. 4 is a view showing a non-limiting example game screen of a gun-battery scene displayed on the display device of the game apparatus shown in FIG. 1.

FIG. 5 is a view showing a non-limiting example game screen of a drift island scene displayed on the display device of the game apparatus shown in FIG. 1.

FIG. 6 is a view showing a non-limiting example discovery range, approach range and passing-each-other range of an appearance object.

FIG. 7 is a view showing another non-limiting example game screen of the base island scene displayed on the display device of the game apparatus shown in FIG. 1.

FIG. 8 is a view showing a further non-limiting example game screen of the base island scene displayed on the display device of the game apparatus shown in FIG. 1.

FIG. 9 is a view showing a non-limiting example method of determining a moving route to a base island stage of the appearance object that passes each other in the base island scene.

FIG. 10A is a view showing a first non-limiting manner of approach and separation of the base island object and the drift island object, FIG. 10B is a view showing a second non-limiting manner of approach and separation of the base island object and the drift island object, and FIG. 10C is a view showing a third non-limiting manner of approach and separation of the base island object and the drift island object.

FIG. 11A is a view showing a fourth non-limiting manner of approach and separation of the base island object and the drift island object, and FIG. 11B is a view showing a fifth non-limiting manner of approach and separation of the base island object and the drift island object.

FIG. 12 is a view showing a non-limiting example memory map of a RAM incorporated in the game apparatus shown in FIG. 1.

FIG. 13 is a view showing non-limiting example specific contents of a data storage area of the RAM shown in FIG. 12.

FIG. 14 is a flowchart showing non-limiting example overall processing of a virtual game by a processor incorporated in the game apparatus shown in FIG. 1.

FIG. 15 is a flowchart showing a first part of non-limiting example game control processing by the processor incorporated in the game apparatus shown in FIG. 1.

FIG. 16 is a flowchart showing a second part of the non-limiting example game control processing by the processor incorporated in the game apparatus shown in FIG. 1, following FIG. 15.

FIG. 17 is a flowchart showing a third part of the non-limiting example game control processing by the processor incorporated in the game apparatus shown in FIG. 1, following FIG. 16.

FIG. 18 is a flowchart showing a fourth part of the non-limiting example game control processing by the processor incorporated in the game apparatus shown in FIG. 1, following FIG. 17.

FIG. 19 is a flowchart showing a fifth part of the non-limiting example game control processing by the processor incorporated in the game apparatus shown in FIG. 1, following FIG. 18.

FIG. 20 is a flowchart showing a first part of non-limiting example island moving processing by the processor incorporated in the game apparatus shown in FIG. 1.

FIG. 21 is a flowchart showing a second part of the non-limiting example island moving processing by the processor incorporated in the game apparatus shown in FIG. 1, following FIG. 20.

FIG. 22 is a flowchart showing a third part of the non-limiting example island moving processing by the processor incorporated in the game apparatus shown in FIG. 1, following FIG. 21.

### DETAILED DESCRIPTION OF NON-LIMITING EXAMPLE EMBODIMENTS

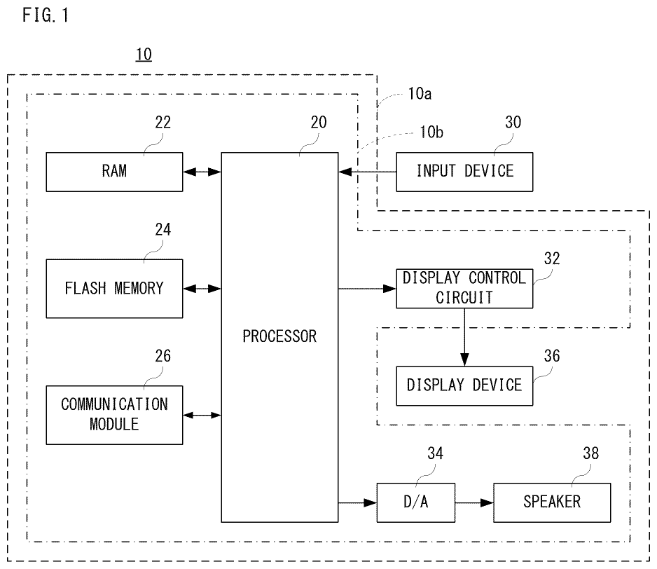

With reference to FIG. 1, a game apparatus 10 that is a non-limiting example information processing apparatus includes a processor 20, and the processor 20 is connected with a RAM 22, a flash memory 24, a communication module 26, an input device 30, a display control circuit 32 and a D/A converter 34. Moreover, the display control circuit 32 is connected with a display device 36, and the D/A converter 34 is connected with a speaker 38.

The processor 20 is in charge of overall control of the game apparatus 10. Specifically, the processor 20 may be an SoC (System-on-a-chip) that incorporates therein functions of a CPU and a GPU. The RAM 22 is a volatile storage medium and is used as a working memory and a buffer memory for the processor 20. The flash memory 24 is a non-volatile storage medium, and is used in order to store a various kinds of application programs, store (save) various kinds of data. For example, the application program and required data are read from the flash memory 24 to be stored in the RAM 22.

However, an application corresponds to applications regarding various kinds of information processing, such as a game application, a document creation application, an email application, a drawing application, a character practice application, a language training application, a learning application, etc.

The communication module 26 has a function that connects to a wireless LAN with a system conformed to the standard of IEEE802.11.b/g, for example. Therefore, the processor 20 transmits or receives data to or from other apparatuses via an access point and a network such as Internet using the communication module 26. For example, other apparatuses correspond to a computer such as a server and other game apparatuses 10. However, it is possible to perform directly transmission and reception of data with other apparatuses using, the communication module 26.

However, in different from the function of connecting to a wireless LAN, the communication module 26 may have a function of performing a short-distance wireless communication. Specifically, the communication module 26 has a function that performs transmitting/receiving of an infrared ray signal with a further apparatus by a predetermined communication system (e.g., an infrared ray system), and a function that performs a wireless communication with the same kind of game apparatuses in accordance with a predetermined communication protocol (e.g., a multilink protocol). In this case, the processor 20 can directly transmit or receive data to or from other same kinds of game apparatuses using the communication module 26, for example. However, instead of the short-distance wireless communication of the infrared ray system, a short-distance wireless communication according to a further wireless communication standard, such as Bluetooth (registered trademark) may be performed.

The input device 30 is a game controller provided with various kinds of push buttons, keys or switches that are provided on the game apparatus 10, for example, and is used by a user or player (hereinafter, referred to as “player”) for various kinds of operations, such as menu selection, instructions in an application. For example, the game controller is provided with an A button, a B button, an X button, a Y button, an L button, an R button, a cross button (and/or a slide stick), etc. However, in a case of a portable game apparatus 10, in addition to the push buttons, keys or switches, a touch panel may be provided as the input device 30.

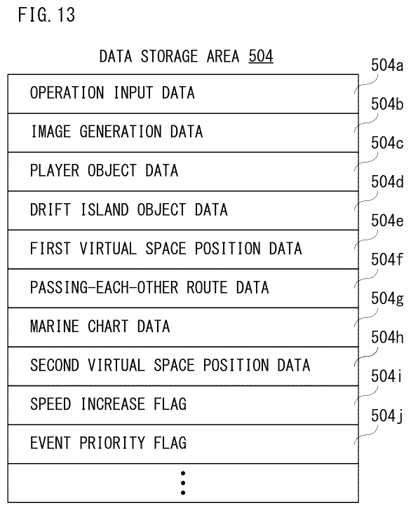

The display control circuit 32 includes a GPU and a VRAM, and the GPU generates in the VRAM, under instructions by the processor 20, image data for displaying various screens on the display device 26 using image generation data 504b (see FIG. 13) stored in the RAM 22, and outputs the generated image data to the display device 36.

The D/A converter 34 converts sound data given from the processor 20 into an analog audio signal, and outputs the same to the speaker 38. However, the sound data may be data regarding the music, such as a sound generated by a character or object, a sound effect and a BGM.

In addition, the electric structure of the game apparatus 10 shown in FIG. 1 is a mere example, and should not need to be limited to this. For example, the communication module 26 may be omitted.

Moreover, the input device 30 may be a game controller provided separately from a main body apparatus 10a of the game apparatus 10, and connected communicably to the processor 20 with a wire or wireless. In this case, the game apparatus 10 constitutes a game system that the main body apparatus 10a and the input device 30 are communicably connected to each other.

Furthermore, in addition to the input device 30, the display device 36 may also be provided separately from the main body apparatus 10b of the game apparatus 10, and connected communicably to the processor 20 with a wire or wireless. In this case, the game apparatus 10 constitutes a game system that the main body apparatus 10b, the input device 30 and the display device 36 are communicably connected to each other. Moreover, as the display device 36, a stationary monitor such as an LCD or an organic EL can be used.

Furthermore, as the game apparatus 10, it is possible to use a game dedicated machine of a portable type or stationary type as well as other information processing apparatuses capable of functioning as a game machine, such as a personal computer, a tablet terminal, a wearable terminal, a cellular phone and a smartphone.

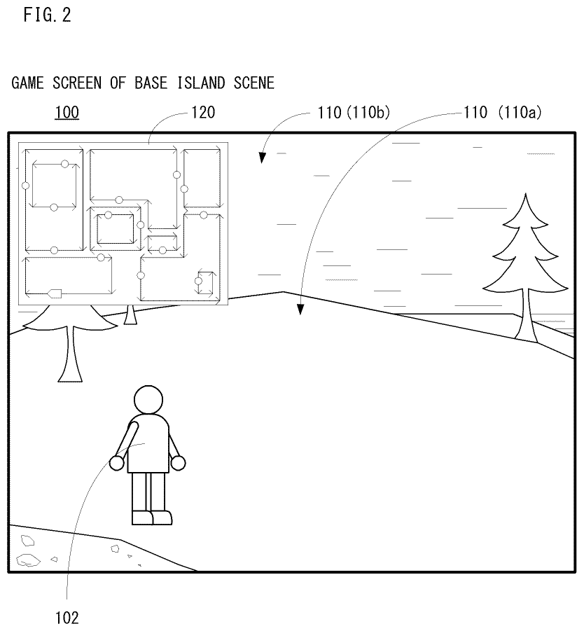

The game apparatus 10 functions also as an image processing apparatus, and generates and outputs (displays) image data corresponding to various screens such as a game screen. Briefly describing, the GPU incorporated in the display control circuit 32 models, under the control by the processor 20, various kinds of character objects in a three-dimensional virtual space. That is, various kinds of character objects are generated or arranged in the virtual space, whereby a certain sight or situation (scene) can be generated. An image that this scene is imaged by a virtual camera (seen from a viewpoint) is displayed on the display device 36. Describing specific image processing, at first, a certain scene is generated in the three-dimensional (or world coordinate system) virtual space, and the scene generated in the virtual space is converted into a coordinate system (i.e., camera coordinate system) that the scene is captured by the virtual camera. For example, an image that is seen from the viewpoint is projected with a perspective manner onto a virtual screen. Next, clipping and hidden-surface-removal processing are performed. Subsequently, brightness (shadow) of a surface of a character object is represented by performing shading. Furthermore, shadowing (i.e., shadow casting) is applied to represent a shadow caused by the character object. Then, texture mapping is performed. Thus, a two-dimensional image regarding a certain scene generated in the three-dimensional virtual space is generated (drawn), and two-dimensional image data corresponding to the generated two-dimensional image is output to the display device 36. In the embodiment, since various kinds of screens are displayed on the display device 36, the three-dimensional image that the virtual space is viewed from the viewpoint is converted into the two-dimensional image; however, in order to distinguish from a case where a two-dimensional game image is generated (or drawn) in the virtual space, as described later, an image that an image of the character object appears three-dimensionally as in a game screen 100 (see FIG. 2) will be referred to as a “three-dimensional game image”.

In addition, in generating the three-dimensional image, instead of applying shadowing, a shadow texture of a simple shape (e.g., circular, oval, triangular or rectangular) may be pasted.

If the player instructs execution of a game application of a virtual game according to the embodiment using the game apparatus 10, the virtual game will be started. The virtual game can be started from the beginning or from a point saved last time.

In the virtual game of the embodiment, it is possible for the player, based on an operation input with respect to a player character object (hereinafter, referred to as “player object”) that is arranged on an object of a virtual island (hereinafter, referred to as “base island stage”) in a first virtual space, to control so that the player object performs an arbitrary action such as movement, etc.

Moreover, in the virtual game, a base island object corresponding to the base island stage rides on a virtual moving route (hereinafter, referred to as “ocean current”) to be automatically moved in a second virtual space. The second virtual space can be referred to as a virtual space that is used in order to generate a world map image to be presented to the player. That is, the base island object is moved on the ocean current according to elapse of time regardless of an operation input by the player. Moreover, in the virtual game, a plurality of ocean currents are provided in an ocean area in the world map, and the player moves the base island object between the ocean currents between which the base island is movable. The first virtual space and the second virtual space may be different virtual space, and may be different portions or areas in the same virtual space.

Moreover, in the virtual game, in the second virtual space, one or more virtual objects (hereinafter, referred to as “drift island object”) corresponding to island objects different from the base island stage (hereinafter, referred to “drift island stage”) also ride on each of a plurality of ocean currents to be moved automatically as elapse of time on the world map. An event that is different from events set to other drift islands is set to each of the plurality of drift islands. However, a plurality of events may be set to a single drift island.

In addition, elapse of time is synchronized between the first virtual space and the second virtual space. That is, during when the player controls the player object in the first virtual space, in also the second virtual space, the base island object corresponding to the base island stage and the drift island object are automatically moved on the virtual moving route.

When the base island object and the drift island object are located close to each other in the second virtual space, it becomes possible to move the player object to the drift island stage from the base island stage. Although the drift island object may exist in a plural number as described above, when the drift island object located near the base island object exists in a plural number, the player object can be moved to the drift island stage that is designated by an operation input by the player.

If the player moves the player object to the drift island stage, a scene of the drift island stage (hereinafter, referred to “drift island scene”) is generated in the first virtual space. However, the drift island scene may be generated by a virtual space other than the first virtual space. The player controls an action of the player object on the drift island stage to clear an event, whereby the drift island stage can be captured. The captured drift island stage is coupled or connected to the base island stage, and the player object can be moved back and forth freely on the drift island object coupled (hereinafter, referred to as “coupled-island object”) to the base island stage according to an operation input by the player.

Therefore, in the virtual game, in the second virtual space, the base island object rides on the ocean current to be moved automatically, and moved to a further ocean current adjacent to that ocean current according to an operation input by the player, whereby the base island object can be moved on the world map.

Thus, the base island object rides on the ocean current to be moved, and is moved to a further ocean current adjacent to that ocean current according to an operation input by the player. As described above, the player can play an event on a stage corresponding to the drift island object (hereinafter, referred to as “drift island stage”) based on an operation input by the player when the base island object and the drift island object close to each other. Then, since the elapse of time is synchronized between the first virtual space and the second virtual space as described above, a positional relationship between the base island object and the drift island object in the second virtual space is changed even while the player is controlling the player object in the first virtual space. Therefore, the player can experience the game progress with high interest different from a conventional one.

Inversely, even while the base island object rides on the ocean current and is being moved in the second virtual space, in the first virtual space, the player can control the player object to execute a predetermined event that is set to the base island stage or the coupled-island stage. Therefore, it is possible to control the player object so as to execute an event in the first virtual space different from the second virtual space while the base island object is being moved in the second virtual space.

In addition, when the base island object and a plurality of the drift island objects ride on the ocean currents and are drift and the base island object and the drift island object encounter each other in the second virtual space, in a scene of the base island stage in the first virtual space (hereinafter, referred to as “base island scene”), an object corresponding to the encountered drift island object (hereinafter, referred to as “appearance object”) is arranged. If the player object is moved to the drift island according to an operation input by the player, the player object captures the drift island stage or the drift island. It becomes a game clear by achieving a final goal. However, if the player object is not moved to the encountered drift island, in the base island scene, the appearance object is moved so that the base island stage and the appearance object pass each other.

As described above, in the virtual game according to the embodiment, since not only the base island object but also the plurality of the drift island objects are moved automatically in the second virtual space, the positional relationships on the world map become more complex, allowing to widen a choice of moving to which the drift island to go.

FIG. 2 is a view showing a non-limiting example game screen 100 of a base island scene displayed on the display device 36 of the game apparatus 10 shown in FIG. 1. As shown in FIG. 2, the game screen 100 of the base island scene is a game image that a certain place in the base island is imaged by the virtual camera and includes a part of the base island stage, and includes an image 102 of the player object and images 110 of a plurality of background objects. Moreover, in the game screen 100 shown in FIG. 2, the images 110 of the background objects include an image 110a of the base island stage and an image 110b of an ocean object. In the base island scene, the player object is arranged in the base island stage, and the base island stage is floating on the ocean object.

However, in an example shown in FIG. 2, the image 110a of the base island stage is a part of the base island stage and is an image of a certain field that the player object is moved and talks with the non-player object (here, referred to as “movable field”). Moreover, the mage 110b of the ocean object is an image of a part of the ocean object that is visible from the certain movable field of the base island stage.

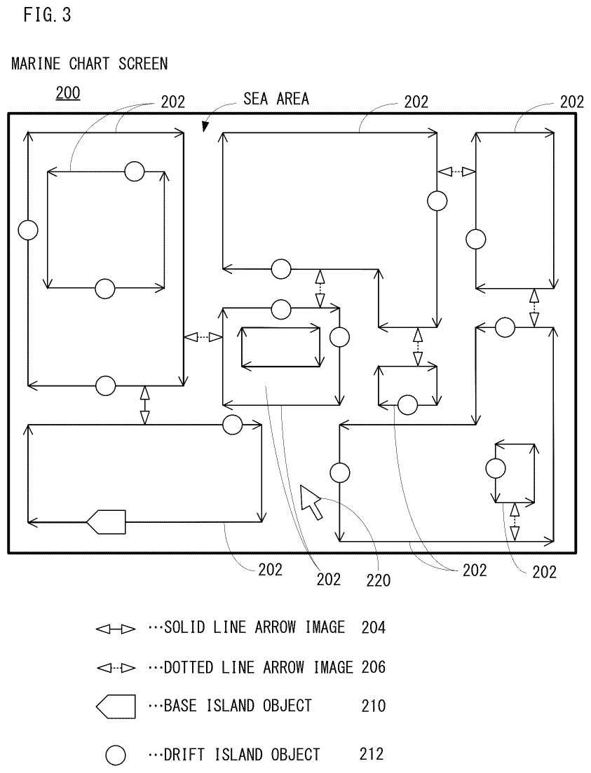

Moreover, an image 120 of the marine chart is displayed in the game screen 100 of the base island scene. The image 120 of the marine chart is an image that a marine chart screen 200 described later (see FIG. 3) is reduced. In FIG. 2, in order to show intelligibly, the image 120 of the marine chart is an image that a part of the marine chart screen 200 is omitted. The base island scene is generated in the first virtual space, and this base island stage is arranged so that a central point of the base island stage may overlap with an origin of the three-dimensional coordinates set to this first virtual space. Since the elapse of the time is synchronized between the first virtual space and the second virtual space as described above, even while the player the virtual game progress in the base island scene, the positional relationship between the base island object and the drift island object is updated in the second virtual space, and the image 120 of the marine chart is also updated according to the updated positions.

In addition, it is not necessary to display the image 120 of the marine chart in the game screen 100. Moreover, it may be possible to set the image 120 of the marine chart is made to be displayed or hidden by the player.

The player controls the player object, thereby to make the player object move inside the base island stage or execute one or more predetermined in-game events (hereinafter, simply referred to as “event”). Events are various events that occur during the play of the virtual game, including not only routine events such as talking, shopping, eating, sleeping (or staying overnight) but also acquiring items, fighting, presenting quests and solving them, and presenting missions and completing them, etc. The event is generated by an action of the player object or generated according to progress of a scenario or a story of the virtual game without being based on an action of the player object. Moreover, there is an event that temporarily occurs only after capturing a certain drift island stage and before going to a next drift island stage. For example, the player object talks with a non-player object character (hereinafter, referred to as “non-player object”) such as an island people arranged within the base island stage; the player object acquires the item such as weapon, medicine, food at a shop provided within the base island stage using an in-game currency in the virtual game; the player object recovers a physical strength point by sleeping in a house or accommodation provided in the base island stage; the player object passes a predetermined item to the non-player object in the base island stage; and the player object finds a predetermined item such as an in-game currency, weapon arranged in the base island stage. Moreover, on the drift island stage and the coupled-island stage other than the base island stage, the player object battles against the enemy object.

Moreover, by defeating the enemy object, the player object acquires the in-game currency, acquires a predetermined item, and is set to be movable to the ocean current adjacent to the ocean current that the base island object is being currently moved in the second virtual space.

However, there is an occasion that the player object is controlled its action, etc. by a computer (in the embodiment, processor 20), regardless of an operation input by the player. The same contents of the events apply to predetermined events set to the drift island object and the coupled-island object, described later. However, a different event is set to each drift island object as described above. The same applies to each coupled-island object.

FIG. 3 is a view showing a non-limiting example marine chart screen 200 displayed on the display device 36 of the game apparatus 10 shown in FIG. 1. If the player instructs to display the marine chart or the world map, a scene is transited (exchanged) to a scene of the marine chart (hereinafter, referred to as “marine chart scene”) from the base island scene, and instead of the game screen 100, the marine chart screen 200 that is a screen of the marine chart scene is displayed. As an example, the marine chart screen 200 includes a part or whole of the world map, which is a two-dimensional game image that a single ocean area is viewed from right above. The world map is constituted by arranging a plurality of the ocean currents in a single virtual ocean area. That is, the marine chart scene is generated in the second virtual space.

The marine chart screen 200 includes images 202 of a plurality of (in FIG. 3, ten pieces) the ocean currents, an image 210 of the base island object and images 212 of a plurality of (in FIG. 3, 14 pieces) drift island objects.

The ocean current is a virtual moving route that the base island object and one or more drift island objects are moved. The base island object and the one or more drift island objects are moved automatically with the lapse of time on a predetermined ocean current among the plurality of ocean currents not only during a time outputting the game screen 100 of the base island scene but also during a time outputting the marine chart screen 200. However, the base island object and the drift island object may be moved along the ocean current. As shown also in FIG. 3, shapes and sizes of respective ocean currents are various. Each ocean current is set as an annular shape of a rectangle, a square or L-letter, and is arranged inside of the ocean area side by side. However, a further ocean current may be arranged inside an ocean current. Moreover, as long as annular, the shape of the ocean current may be a triangular, a diamond, a polygon more than a pentagon, a circular or an oval.

Moreover, in the marine chart screen 200, as for a space between two ocean currents after becoming movable, an image 204 representing that the base island object can move therebetween (in the embodiment, a solid line arrow image that is an image of solid line arrow each having both ends that arrow marks are displayed) is displayed, and as for a space between two ocean currents before becoming movable, an image 206 representing that the player object cannot move therebetween (in the embodiment, a dotted line arrow image that is an image of dotted line arrow each having both ends that arrow marks are displayed) is displayed. The dotted line arrow image 206 is changed to the solid line arrow image 204 if a predetermined movable condition is satisfied. The predetermined movable condition is that the story progresses to a predetermined point or position, that the player object moves to one or more predetermined drift island objects, that a predetermined story is released, and that a predetermined event is executed. In the marine chart screen 200, as for a space between the two ocean currents that do not become movable, the dotted line arrow image 206 is not displayed between the two ocean currents.

However, if the player object uses a predetermined item and captures one or more predetermined drift island objects, the dotted line arrow image 206 may be arranged between the images 202 of two ocean currents between which the solid line arrow image 204 and the dotted line arrow image 206 are not displayed, and the bidirectional solid arrow image 204 may also be arranged therebetween. That is, it is possible to change a state between two ocean currents that do not become movable to a state before that the two ocean currents become movable or a state that the two ocean currents become movable.

In addition, after the base island object is moved on all or the predetermined number or more of the ocean currents as the virtual game progresses, for example, the base island object may be made movable to a further ocean current freely according to an operation input by the player regardless of the position that the bidirectional solid arrow image 204 is being displayed.

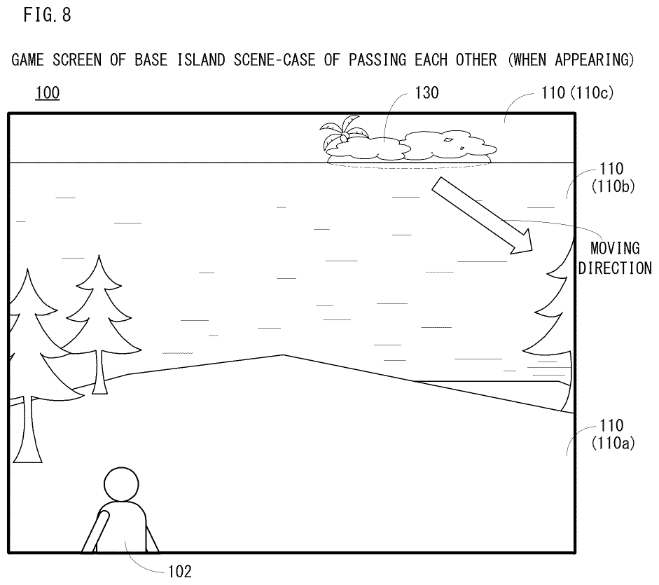

The image 210 of the base island object is an image that the base island object is simplified or symbolized, and is, in an example shown in FIG. 3, a pentagonal image. Moreover, the image 212 of the drift island object is an image that the drift island object is simplified or symbolized, and is, in the example shown in FIG. 3, a circular image. However, the base island object in the marine chart screen 200 corresponds to the base island stage in the game screen 100 of the base island scene. Moreover, the drift island object in the marine chart screen 200 corresponds to the appearance object (see FIG. 8) in the game screen 100 of the base island scene.

In the second virtual space, the base island object and each of a plurality of drift island objects ride on any of the ocean currents to be moved. Therefore, in the world map, a coordinate system is set, which is for managing not only positions of the images 202 of respective ocean currents, respective solid line arrow images 204 and respective dotted line arrow images 206 but also positions of the base island object, respective drift island objects and a designation image 220, i.e., the two-dimensional coordinates. In this coordinate system, the images 202 of respective ocean currents, respective solid line arrow images 204 and the images of respective dotted line arrow images 206 are arranged fixedly, the positions of the base island object and the respective drift island objects are changed automatically, and the position of the designation image 220 is changed according to an operation input by the player. However, when the movable condition is satisfied, the dotted line arrow image 206 is changed to the solid line arrow image 204.

Furthermore, the image 202 of each of the ocean currents is displayed using an arrow mark, and a direction of an arrowhead is indicative of a direction of the ocean current. Moreover, a speed of the ocean current is set to each of the ocean currents. Therefore, the base island object and the plurality of drift island objects are moved in directions of the ocean currents on which they ride at the speed of the ocean currents on which they ride, respectively.

However, when a speed increase condition is satisfied, the base island object is moved at a speed that the speed of the ocean current is increased by a predetermined speed. The speed increase condition is a predetermined condition that a speed of the base island object is temporarily (a first predetermined time period, and e.g., 30 seconds) increased, which is that the player object uses a predetermined item, or that the player object passes a predetermined item to a specific non-player object. A reason why the speed of the base island object is temporarily increased only when the speed rise condition is satisfied is for preventing the interest of playing the virtual game from being reduced. More specifically, if the speed of the base island object is made to be increased freely, during a time that the base island object rides on the ocean current to be moved, the base island object is rapidly moved in the second virtual space without playing within the base island stage or the coupled-island stage in the first virtual space by the player, the interest will be reduced.

Although the speed of the base island object is increased temporarily in the embodiment, the speed may be decreased temporarily. In this case, when satisfying a speed decrease condition, the base island object is moved at a speed that the speed of the ocean current is decreased by a predetermined speed. The speed decrease condition is a condition that the speed of the base island object is decreased temporarily, which is that the physical strength point of the player object is less than a predetermined value, or that the player object receives a predetermined attack from the enemy object.

That is, by satisfying a speed change condition such as the speed increase condition and the speed decrease condition, it is possible to change the speed of the base island object.

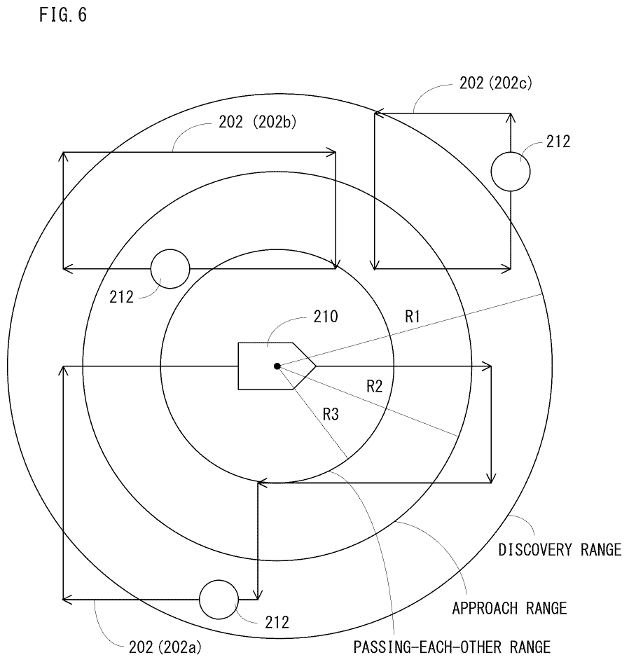

Moreover, the designation image 220 is provided in the marine chart screen 200. The designation image 220 is moved by an operation input by the player and information of the drift island object corresponding to the image 212 designated by the designation image 220 is displayed. In the embodiment, the information of the drift island object includes a name of the drift island, a name of the specific non-player object existing on the drift island, a content of an event set to the drift island object, a reward that is obtained when clearing the predetermined event, etc. However, it is possible not to display information of the drift island object that has not yet discovered. The drift island object that has not yet discovered is a drift island object that is beyond a discovery range of the base island object (see FIG. 6) and has never come close to the discovery range of the base island object.

The player can see all or a part of the world map, i.e., the ocean area by displaying the marine chart screen 200. Moreover, it is possible to acquire information of the drift island object corresponding to the image 212, and to time, based on a positional relationship between the image 210 and a certain image 212 and the moving direction, a timing the base island object corresponding to an image 210 and the drift island object corresponding to a certain image 212 close to each other. Moreover, it is also possible to know other ocean currents to which the base island object is movable.

Moreover, when knowing that the base island object and the drift island object that the player wishes to move to or capture are close to each other in the marine chart screen 200, the player makes the player object move to a position provided with a virtual gun-battery object (hereinafter, referred to as “gun-battery object”) in the base island stage by changing (or returning) to the base island scene. If the player object arrives at the position that the gun-batter object is arranged, a scene is changed to a gun-battery scene from the base island scene.

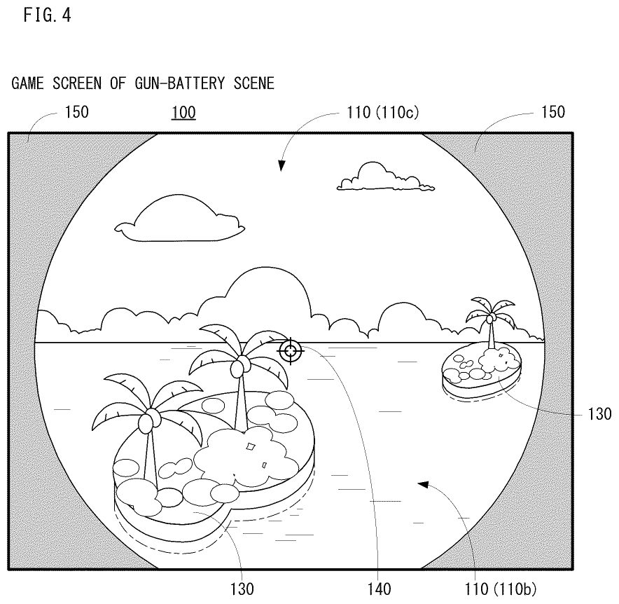

FIG. 4 is a view showing a non-limiting example game screen 100 of the gun-battery scene displayed on the display device 36 of the game apparatus 10 shown in FIG. 1. As shown in FIG. 4, the game screen 100 of the gun-battery scene is a three-dimensional game image that the player object looks an outside of the base island stage from the gun-battery object, and images 110 of the background objects such as an image 110b of an ocean object and an image 110c of a sky object are displayed in addition to an image 130 of an appearance object.

The game screen 100 of the gun-battery scene is displayed using a positional relationship of the gun-battery object and the appearance object, etc. in the first virtual space. As an example, the virtual camera is arranged in a position of the gun-battery object in the base island scene, and an image that is imaged by this virtual camera is displayed as the game screen 100 of the gun-battery scene.

As shown in FIG. 4, in the game screen 100 of the gun-battery scene, a sight image 140 is displayed on the center of the screen, and frame images 150 are displayed on both sides of the screen. That is, the sight image 140 is drawn in a position that overlaps with a line of sight of the virtual camera. The frame images 150 are displayed in order to express that the player object is looking into the binocular telescope, but it is not necessary to display the frame images 150. The sight image 140 and the frame images 150 are displayed in front of the images (110, 130) of the respective objects.

If the player moves the sight image 140 and the frame images 150 to make the sight image 140 point the image 130 of an appearance object by changing the direction of the virtual camera, the player object is moved to the drift island stage corresponding to the image 130 of the appearance object that is pointed by the sight image 140. For example, the player object is flown to the drift island stage corresponding to the image 130 of the appearance object that is pointed by the sight image 140 by a virtual gun object provided in the gun-battery object. That is, if the player moves the sight image 140 and the frame images 150, the direction of the gun object is also moved.

However, in order to stop a movement of the player object to the drift island stage, the player may simply operate the B button, so that the gun-battery scene is ended and the scene can be returned to the base island scene. That is, the scene is changed from the gun-battery scene to the base island scene. At this time, the player object is arranged near a place that the gun-battery object is arranged in the base island stage.

In the embodiment, if the player makes the sight image 140 point the image 130 of the appearance object, the player object is automatically moved to the drift island stage corresponding to the image 130 of the appearance object that is pointed by the sight image 140. That is, if an event occurrence condition that the sight image 140 is pointed by the image 130 of the appearance object is satisfied, a predetermined event that the player object is moved to the drift island stage is executed.

However, the event occurrence condition and the predetermined event do not need to be limited. Therefore, it is conceivable that the player makes the sight image 140 point the image 130 of the appearance object, and instructs a movement of the player object, and then, the player object can be moved to the drift island stage corresponding to the image 130 of the appearance object that is pointed by the sight image 140. In such a case, when the player makes the sight image 140 point the image 130 of the appearance object, a predetermined event that information of the drift island stage corresponding to the image 130 of this appearance object is displayed may be made to be executed. The information of the drift island stage includes, similar to a case where the marine chart screen 200 is being displayed, a name of the drift island, a name of a specific non-player object existing in the drift island, a content of a predetermined event set to the drift island object, etc.

However, a distance that the player object is movable, i.e., a movable range is set in advance, and therefore, the player object cannot be moved to the drift island stage exceeding the movable range. Moreover, if not exceeding the movable range, it is possible for the player object to be moved to a drift island stage corresponding to the drift island object that is moving on the ocean current that is different from the ocean current that the base island object is being moved in the second virtual space. As an example, the movable range is an “approach range” described later (see FIG. 6). However, the movable range may be expanded by using a predetermined item.

If the player object is moved to the drift island stage, the game screen 100 of a scene in the drift island stage that the player object is moved, i.e., the drift island scene is displayed on the display device 36. That is, the scene is changed from the gun-battery scene to the drift island scene. In the game screen 100 of the drift island scene, manners that the player object is moved in the drift island stage and that the predetermined event that is set to the drift island stage is performed and so on are displayed.

In addition, although having described that the elapse of time is synchronized between the first virtual space and the second virtual space, the elapse of time is stopped during the player object is moved to the drift island stage. That is, while the player controls the player object on the drift island stage, in the second virtual space, the base island object corresponding to the base island stage and the drift island object remain in the same position without moving. This is because the positional relationship between the drift island object and the base island object becomes displaced when not stopping the elapse of time while moving to the drift island stage, and therefore, it becomes impossible for the player object to return naturally to the base island object.

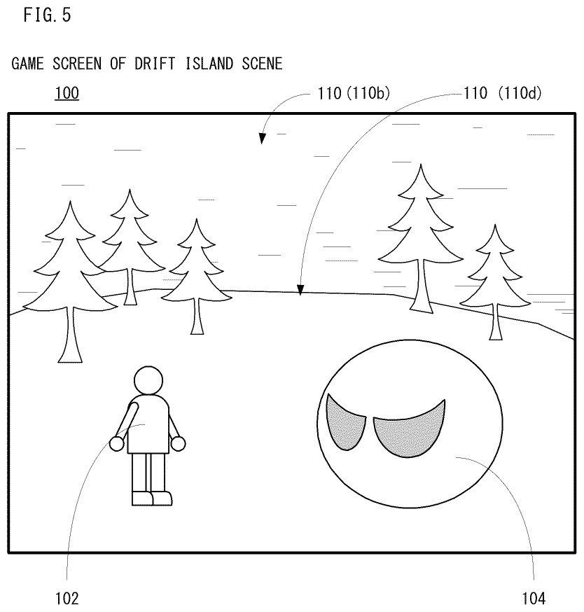

FIG. 5 is a view showing a non-limiting example game screen 100 of the drift island scene displayed on the display device 36 of the game apparatus 10 shown in FIG. 1. As shown in FIG. 5, the game screen 100 of the drift island scene is a game image of the drift island stage that the virtual camera images a certain place in the drift island to which the player object is moved, and includes an image 102 of the player object and an image 104 of the enemy object, and further, images 110 of a plurality of the background objects. Moreover, in the game screen 100 shown in FIG. 5, the images 110 of the background objects include an image 110d of the drift island stage and an image 110b of the ocean object. In the drift island scene, the player object is arranged in the drift island stage, and the drift island stage is floating on the ocean object.

However, in an example shown in FIG. 5, a battle with the enemy object is set to the drift island stage as a predetermined event, and the image 110d of the drift island stage is a part of the drift island stage, and is an image of a certain field that the player object and the enemy object battle with each other (here, referred to as “battle field”). Moreover, the image 110b of the ocean object is an image of the ocean object that can be seen from a certain battle field of the drift island stage.

If the predetermined event set to the drift island stage is executed and the drift island stage is captured, the player object is returned to a predetermined position of the base island stage, and a predetermined effect due to having captured the drift island stage is performed. The predetermine effect corresponds that the captured drift island stage is coupled to the base island stage, a predetermined item is acquired, a new drift island object appears, etc., and the predetermined effect is set to each drift island stage. However, this drift island stage is captured by executing the predetermined event set to the drift island stage is executed by the player object defeating the enemy object, solving a quest, or accomplishing a mission.

When the captured drift island stage is coupled to the base island stage, an object corresponding to this coupled-island stage (hereinafter, referred to as “coupled-island stage”) (i.e., the drift island object corresponding to the captured drift island stage) is eliminated from the world map, i.e., the second virtual space, and the player object becomes able to back and forth between the base island stage and the coupled-island stage at any time. That is, regardless of the positional relationship in the second virtual space, the player object becomes able to back and forth between the base island stage and the coupled-island stage at any time.

As an example, a junction port to each coupled-island stage is provided in the base island stage, and when the player object is moved according to an operation input by the player and arrives at the contact port, the player object is moved to the coupled-island stage corresponding to the contact port it arrived at. Moreover, a junction port to the base island stage is provided in the coupled-island stage, and when the player object is moved according to an operation input by the player and arrives at the junction port, the player object is moved to the base island stage.

If the player object is moved to the coupled-island stage, the game screen of a scene in the coupled-island stage (hereinafter, referred to as “coupled-island scene”) is displayed on the display device 36. That is, the scene is changed from the base island scene to the coupled-island scene. The same predetermined event as before the capture may be set to the coupled-island stage, or a predetermined event different from before the capture may be set. Although illustration is omitted, the game screen of the coupled-island scene is a screen that the image of the marine chart shown in FIG. 2 is displayed onto the game screen of the drift island scene including the drift island stage before the capture.

However, although it is described that the captured drift island stage is coupled to the base island stage for convenience, since the drift island object corresponding to the captured drift island stage is eliminated from the second virtual space, when determining the positional relationship between the coupled-island stage and the drift island stage in the coupled-island scene, it is assumed that the coupled-island object is overlapped with the base island object, i.e., existing in the same position in the second virtual space.

On the other hand, when the predetermined event set to the drift island stage is executed and resulted in that the player object is defeated by the enemy object, the quest is not solved or the mission is not accomplished, that is, when capture of the drift island stage is failed, it becomes that the player object is returned to a predetermined position of the base island stage and the game is resumed from the predetermined position, or the game is resumed from a position the capture is failed.

As described above, the player object is moved to the drift island stage corresponding to the appearance object that exists in the movable range (e.g., “approach range” described later), and captures this drift island stage. Therefore, when the appearance object does not exist within the movable range, the base island stage and the coupled-island stage are moved on the ocean current in the second virtual space, and it is waited for, in the base island scene or the coupled-island scene, that the appearance object approaches into the movable range, that is, that the base island stage and the coupled-island stage encounter with the appearance object.

In the base island scene or the coupled-island scene, in waiting, the player controls the player object to execute the predetermined event set to the base island stage or the coupled-island stage. The player can recover the physical strength point of the player object in the base island stage or the coupled-island stage, or acquire a predetermined item in the base island stage or the coupled-island stage by controlling the player object to execute the predetermined event. That is, the player controls the player object to play in the base island stage or the coupled-island stage, and to perform a preparation for capturing the drift island stage corresponding to the appearance object that the base island stage or the coupled-island stage encounters next.

Moreover, in the base island scene or the coupled-island scene, if the base island stage or the coupled-island stage and the appearance object close to each other within a predetermined distance or range (hereinafter, referred to as “discovery range”) during waiting, it is notified that the appearance object is discovered. As shown in FIG. 6, the discovery range is equivalent to a circular range having a radius R1 (e.g., 150 meters in the second virtual space) centering on the center of the base island object in the second virtual space. Therefore, determination on whether the appearance object approaches the discovery range of the base island stage or the coupled-island stage is performed in the second virtual space. This applies also to a case where it is determined whether the appearance object approaches the approach range of the base island stage or the coupled-island stage described later, and a case where it is determined whether the appearance object approaches a passing-each-other range of the base island stage. However, as described above, since the drift island object corresponding to the coupled-island stage is eliminated from the second virtual space, when determining the positional relationship between the appearance object and the drift island object corresponding to the coupled-island stage, the position of the base island object is used.

In addition, as an example, a size in a horizontal direction of each of the base island object and the drift island object is set as a size that a radius is settled in a circle of approximately 30 meters in the second virtual space. This applies to the first virtual space.

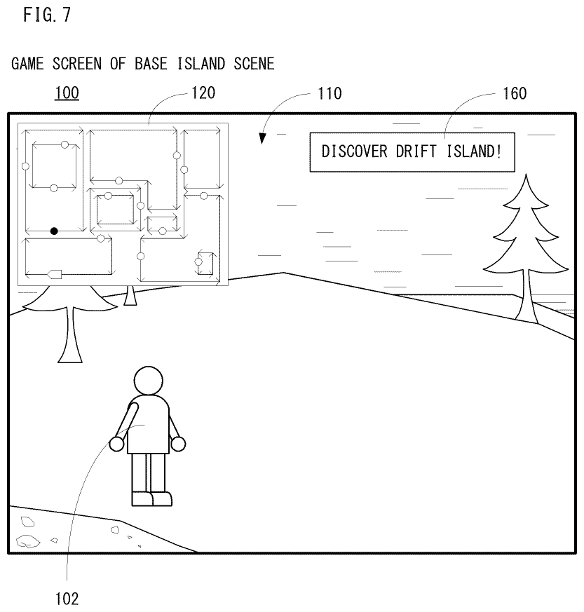

As shown in FIG. 7, in the image 120 of the marine chart, an image corresponding to the discovered appearance object is displayed to be identifiable visually. Although the image corresponding to the discovered appearance object is filled in black in an example shown in FIG. 7, in fact, the image in question is displayed blinking, brightness of the image is increased or a decorative image such as a star-shaped image is superimposed on the image. Moreover, in the game screen 100 of the base island scene, a text indicating that the appearance object is discovered is displayed. As shown in FIG. 7, as an example, a text “discover drift island!” is displayed inside a display frame of the image 160 of the display frame.

However, in the image 120 of the marine chart, either may be adopted displaying the image corresponding to the discovered appearance object to be identifiable visually and displaying the text indicating that the appearance object is discovered. Moreover, a notifying sound or a notifying voice may be output instead of or in addition to notifying in the screen display that the appearance object is discovered. This applies to a case of notifying that the appearance object is approaching. Such notifying processing is the same in the coupled-island scene.

In addition, although it is notified that the appearance object is discovered when the appearance object approaches the discovery range in the embodiment, only regarding a new appearance object, i.e., an appearance object has not yet been discovered, it may be notified that the appearance object is discovered

Moreover, in the base island scene or the coupled-island scene, if the base island stage or the coupled-island stage and the appearance object close to each other within a range narrower than the discovery range (hereinafter, referred to as “approach range”) during waiting, it will be notified that the appearance object is approaching. As shown in FIG. 6, the approach range is equivalent to a circular range of a radius R2 (e.g., 100 meters in the second virtual space) centering on the center of the base island object in the second virtual space. As shown also in FIG. 6, the radius R2 is smaller than the radius R1.

Thus, although the player controls the player object to play in the base island stage or the coupled-island stage and to perform preparation for capturing the drift island stage corresponding to the appearance object that passes the base island stage or the coupled-island stage each other or encounters next, by notifying in the meantime that the appearance object corresponding to the drift island object that comes close to the base island object being moved is discovered and that the appearance object is approaching, the player can make the player object move to the drift island stage corresponding to the appearance object that approaches the movable range.

However, even if the player does not make the player object move to the drift island stage corresponding to the appearance object that approaches the movable range, since the base island object corresponding to the base island stage and the drift island object corresponding to the appearance object are orbit on the ocean currents, the player can make the player object move to the drift island stage corresponding to the appearance object that approaches the movable range, in an encounter chance next or thereafter.

Therefore, either one of having discovered the appearance object and approaching of the appearance object may be notified.

Furthermore, in the embodiment, if the base island stage and the appearance object approach within a range narrower than the approach range (hereinafter, referred to as “passing-each-other range”), a game screen 100 of a manner that the base island stage and the appearance object are passing each other is displayed on the display device 36. As shown in FIG. 6, the passing-each-other range is equivalent to a circular range of a radius R3 (e.g., 50 meters, in the second virtual space) centering on the center of the base island object in the second virtual space. As shown also in FIG. 6, the radius R3 is smaller than the radius R1 and the radius R2.

In the following, it will be described on a case where the base island stage and the appearance object pass each other in the base island scene.

Here, as also seen from the marine chart screen 200 shown in FIG. 3, since directions of respective ocean currents are different from each other and speeds of the respective ocean currents are also different from each other in the embodiment, there are cases where the base island object and the drift island object pass each other, move side by side, or move orthogonally. Thus, there are various manners of approach and separation between the base island object and the drift island object. However, in order to show the manner of approach and separation more intelligibly, in the embodiment, in the base island scene, the game screen 100 of a manner that the base island stage and the appearance object pass each other is displayed. That is, regardless of the manner of approach and separation between the base island object and the drift island object in the second virtual space, in the game screen 100 of the base island scene, it is expressed that the appearance object appears in front of the base island stage and the base island stage and the appearance object pass each other.

Moreover, in the embodiment, in the base island scene, the base island stage is arranged fixedly at an origin of the three-dimensional coordinates set to the first virtual space, and thus, not be moved. Therefore, in the game screen 100, the appearance object appears in a position that is in front of the base island stage and separated from this base island stage by a first predetermined distance (in the embodiment, a distance equal to the radius R3 of the passing-each-other range), and approaches the base island stage gradually, and then, passes side the base island stage so as to pass the base island stage each other. That is, the above-described notification that the appearance object has been discovered and that the appearance object is approaching is a notice of an appearance (or arrangement) of the appearance object. Therefore, it is possible for the player to know in advance that the appearance object will appear.

Moreover, in the base island scene, when the base island stage and the appearance object pass each other, the appearance object is moved on a course at a right side or on a course at a left side of the base island stage. The right side course or the left side course is a lane of the ocean current in the base island scene.

FIG. 8 is a view showing a non-limiting example game screen 100 of the base island scene in case the base island stage and the appearance object pass each other. Even when the base island object and the drift island object pass each other, move side by side or move orthogonally in the second virtual space, as described above, it is expressed as such that the appearance object appears in front of the base island stage and the base island stage and the appearance object pass each other. In the game screen 100 of FIG. 8, an upper part of the screen is a front side of the base island stage. Moreover, a left side of the screen is a left of the base island stage, a right side of the screen is a right of the base island stage, and a lower part of the screen is a rear side of the base island stage. More specifically, in FIG. 8, a course that the appearance object is moved is determined as a right side course, and the game screen 100 regarding a time point that the image 130 of the appearance object is displayed in a position corresponding to a start point thereof. As shown in FIG. 8, when the base island stage and the appearance object pass each other, the image 120 of the marine chart is hidden. Moreover, in different from a normal base island scene, in the game screen 100 shown in FIG. 8, in order to display the image 130 of the appearance object, the position and the direction of the virtual camera differ compared with a case of displaying the game screen 100 shown in FIG. 2.

As shown in FIG. 8, when the appearance object is moved on the right side course, the image 130 of this appearance object is arranged in front of the base island stage and slightly to the right of the center of the image 110 of the base island stage image, and as shown by a white arrow, while being moved diagonally to the right rear of the base island stage, the appearance object approaches the image 110a of the base island stage and is moved to an outside of the game screen 100. Therefore, the game screen 100 of a manner that the base island stage and the appearance object pass each other is displayed.

Although illustration is omitted, when the appearance object is moved in the left side course, the image 130 of the appearance object is arranged in front of the base island stage and slightly to the left of the center of the image 110a of the base island stage, and while being moved diagonally to the left rear of the base island stage, the appearance object approaches the image 110a of the base island stage and is moved to an outside of the game screen 100.

Whether the appearance object is moved in the right side course or moved in the left side course of the base island stage is determined based on a positional relationship between the base island object and the drift island object in the second virtual space.

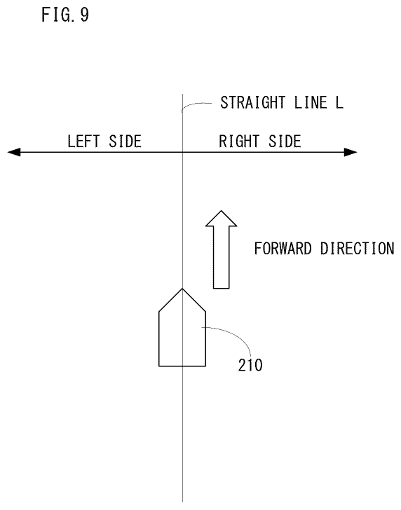

FIG. 9 is a view showing a non-limiting example positional relationship between the base island object and the drift island object in the second virtual space. However, in FIG. 9, the image 210 of the base island object is shown but the image 212 of the drift island object is omitted.

As shown in FIG. 9, a straight line L is set as a reference for determining a course in which the appearance object is moved, which passes the center of the base island object and extends in parallel with a forward direction of the base island object. When the drift island object corresponding to the appearance object for passing each other is located in the right side of the straight line L with respect to the forward direction of the base island object, a course in which the appearance object corresponding to the drift island object is moved in the base island scene is determined as the right side course, and when the drift island object corresponding to the appearance object for passing each other is located in the left of the straight line L, a course in which the appearance object is moved in the base island scene is determined as the left side course. Therefore, when the base island stage and the appearance object pass each other in the base island scene, the appearance object can be moved in accordance with the positional relationship between the base island object and the drift island object in the second virtual space.

However, in the embodiment, when the drift island object is located on the straight line L, a course in which the appearance object for passing each other is moved in the first virtual space is determined as the right side course (may be the left side course).

In any case of the course of the right side course and the left side course, each of a start point and an end point of the course is set in advance on the basis of the origin of the three-dimensional coordinates set in the first virtual space that the base island stage is arranged. As an example, the start point of the course is set using a distance in the base island scene, i.e., the first virtual space, which is equivalent to a distance of the radius R3 of the passing-each-other range in the second virtual space. The end point of the course is set such that when the appearance object is moved so as to pass the base island object each other in the base island scene, the appearance object is moved to an outside of the game screen 100 while the base island stage and the appearance object do not collide with each other.

Moreover, when the base island stage and the appearance object pass each other in the first virtual space, a time from the image 130 of the appearance object is displayed (or appears) in the game screen 100 until the image 130 is hidden (or eliminated) (hereinafter, referred to as “stay time”) is determined in accordance with a manner of approach and separation of the base island object and the drift island object in the second virtual space.

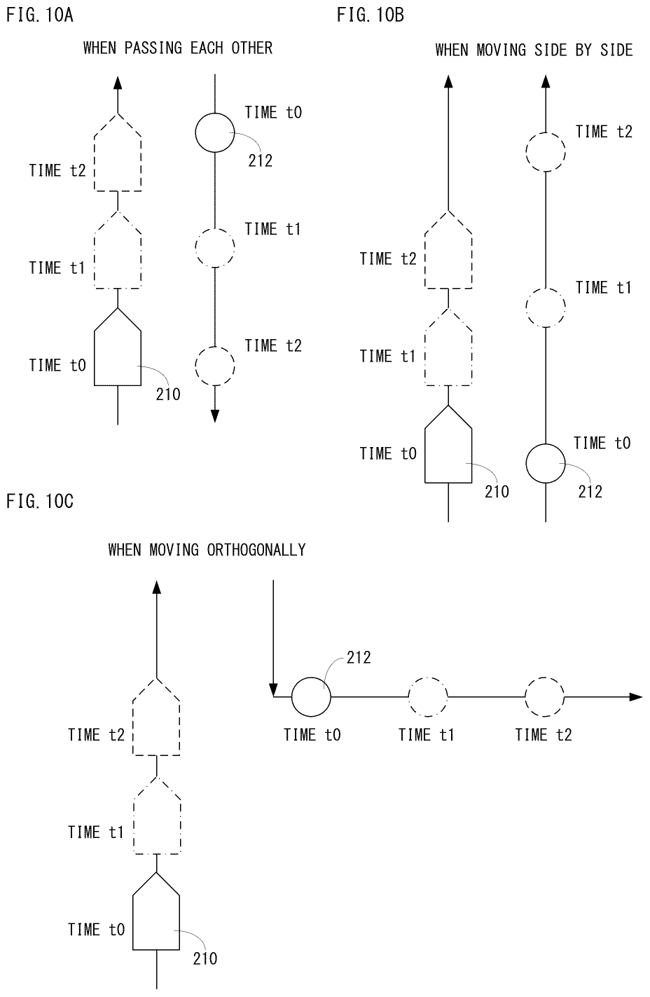

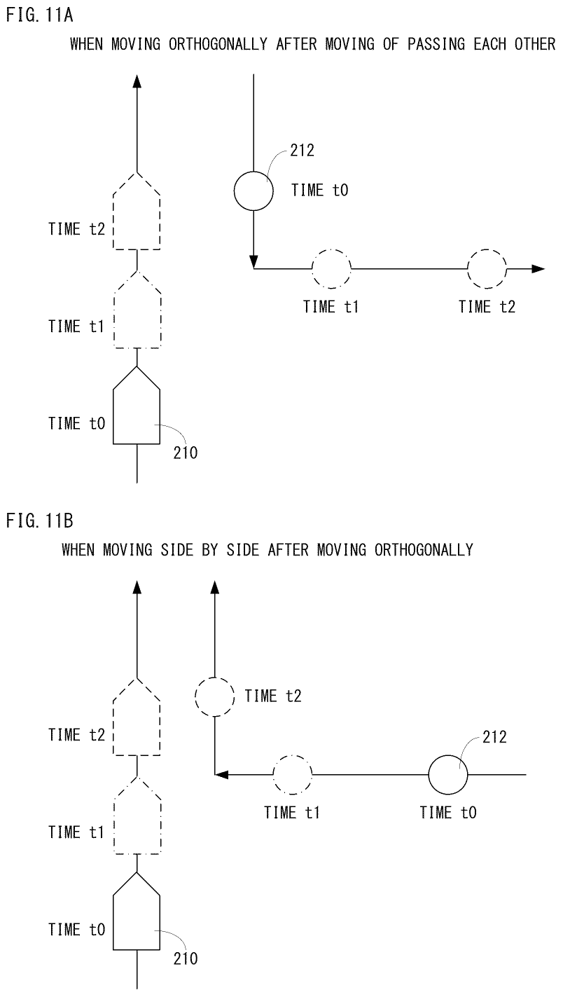

FIG. 10A is a view showing a first non-limiting example determination method of the stay time, FIG. 10B is a view showing a second non-limiting example determination method of the stay time, and FIG. 10C is a view showing a third non-limiting example determination method of the stay time. In FIG. 10A-FIG. 10C, only the ocean currents required for explanation of the stay time are indicated. This applies to FIG. 11A and FIG. 11B.

In FIG. 10A-FIG. 10C, times t0, t1 and t2 are indicated beside the image 210 and the image 212 in order to show that the base island object and the drift island object are moves as elapse of time. With respect to a certain time t0 as a reference, the time t1 is a time after the time t0, and the time t2 is a time after the time t1. However, a time interval between the time t0 and the time t1 and a time interval between the time t1 and the time t2 are the same. This applies to FIG. 11A and FIG. 11B.

In the embodiment, when the base island object and the drift island object pass each other in the second virtual space as shown in FIG. 10A, the stay time is set to a predetermined time (hereinafter, referred to “second predetermined time”) regardless of moving speeds thereof. For example, the second predetermined time is approximately five (5) seconds.

On the basis of this second predetermined time, the stay time is respectively determined by correcting the second predetermined time for a case where the base island object and the drift island object are moved side by side in the second virtual space and a case where the base island object and the drift island object are moved orthogonally in the second virtual space.

When the base island object and the drift island object move side by side in the second virtual space as shown in FIG. 10B, a relative speed is small compared with a case of passing-each-other, and therefore, the stay time is made to be longer. Therefore, when the base island object and the drift island object are moved side by side in the second virtual space, the stay time is determined as a time that the second predetermined time multiplied by a first predetermined magnification (for example, 1.6 times).

However, since a moving speed of the drift island object is larger than a moving speed of the base island object in a case shown in FIG. 10B, a time that the drift island object can be seen from the base island object is longer compared with a case where the moving speed of the drift island object is smaller than the moving speed of the base island object. Therefore, when the base island object and the drift island object move side by side in the second virtual space, the predetermined magnification may be set as different values in a case where the moving speed of the drift island object is larger than the moving speed of the base island object and in a case where the moving speed of the drift island object is smaller than the moving speed of the base island object, respectively.

Moreover, when the base island object and the drift island object are moved orthogonally while being separated from each other in the second virtual space as shown in FIG. 10C, since the drift island object is moved while being separated in a direction perpendicular with respect to the forward direction of the base island object, a relative speed is small compared with a case of passing-each-other. However, as for the forward direction of the base island object, since the moving speed of the drift island object is 0 (zero), a relative speed is larger than a case where the base island object and the drift island object move side by side. Therefore, when the base island object and the drift island object are moved orthogonally while being separated from each other in the second virtual space, the stay time is determined as a time that the second predetermined time multiplied by a second predetermined magnification (e.g., 1.4 times).

In addition, although illustration is omitted, when the drift island object is moved in a reverse direction with respect to a case shown in FIG. 10C, that is, when the base island object and the drift island object are moved orthogonally while approaching in the second virtual space, since the drift island object is moved while approaching a direction perpendicular to the forward direction of the base island object, a relative speed is the same as a case of passing-each-other. Therefore, in this case, the stay time is determined as the second predetermined time.

FIG. 11A is a view showing a fourth non-limiting example determination method of the stay time, and FIG. 11B is a view showing a fifth non-limiting example determination method of the stay time. In examples shown in FIG. 11A and FIG. 11B, a moving course of the drift island object with respect to the base island object in the second virtual space is changed on the way. In also such a case, the stay time is determined by correcting the second predetermined time.

When the drift island object is moved to pass the base island object each other, and then, is moved orthogonally while being separated from the base island object in the second virtual space as shown in FIG. 11A, in comparison with a case where the base island object and the drift island object are only moved as passing each other in the second virtual space as shown in FIG. 10A, a relative speed becomes smaller in a portion that the base island object and the drift island object are moved while being separated from each other. In other words, as shown in FIG. 10C, in comparison with a case where the base island object and the drift island object are only moved orthogonally while being separated from each other in the second virtual space, a relative speed becomes larger in a portion that the base island object and the drift island object are moved as passing each other. Therefore, when the drift island object is moved while being separated from the base island object after the drift island object is moved as passing the base island object each other in the second virtual space, the stay time is determined as a time that the second predetermined time multiplied by the third predetermined magnification (e.g., 1.2 times).

Although illustration is omitted, if a direction that the base island object is moved is made in a reverse direction in FIG. 11A, when the drift island object is moved while being separated from the base island object after the drift island object and the base island object are moved side by side in the second virtual space, the stay time becomes longer because a relative speed is small compared with a case of passing-each-other in a portion that the both objects are moved side by side. Therefore, when the drift island object is moved with the base island object side by side, and then, is moved orthogonally while being separated from the base island object in the second virtual space, the stay time is determined as a time that the second predetermined time multiplied by a fourth predetermined magnification (e.g., 1.3 times).

When the drift island object and the base island object are moved side by side in the second virtual space after the drift island object is moved orthogonally while approaching the base island object as shown in FIG. 11B, in comparison with a case where the base island object and the drift island object are only moved side by side in the second virtual space as shown in FIG. 10B, a relative speed becomes smaller in a portion that the drift island object is moved orthogonally while approaching the base island object. In other words, as described above, a relative speed becomes smaller in a portion that the base island object and the drift island object are moved side by side in the second virtual space compared with a case where the drift island object is moved orthogonally while approaching the base island object. Therefore, when the base island object and the drift island object are moved side by side in the second virtual space after the drift island is moved perpendicular to the base island object, the stay time is determined as a time that the second predetermined time multiplied by a fifth predetermined magnification (e.g., 1.5 times).

Although illustration is omitted, as for a case where a direction that the base island object is moved made to be inversed in FIG. 11B, when the drift island object is moved while passing the base island object each other in the world map after the drift island is moved orthogonally while approaching the base island object, the stay time is determined as a time that the second predetermined time multiplied by the third predetermined magnification as similar to a case where the drift island object is moved orthogonally with respect to the base island object in the second virtual space after the drift island object is moved while passing the base island object each other as shown in FIG. 11A.

Moreover, although illustration is omitted, also for a case where a moving course of the base island object is changed, the stay time is determined by correcting the second predetermined time. For example, in FIG. 11A, the base island object may turn to the right or may turn to the left between the time t0 and the time t2. In such a case, the drift island object is moved with the base island object side by side or the drift island object is moved while being separated from the base island object after the drift island object is moved while passing the base island object each other.

As in the former, when the drift island object is moved with the base island object side by side after the drift island object is moved while passing the base island object each other, a relative speed becomes smaller in a portion that the base island object and the drift island object are moved side by side compared with not only a case of only passing-each-other but also a case where the drift island object is moved orthogonally while being separated from the base island object after passing each other as shown in FIG. 11A. Therefore, in this case, the stay time is determined as a time the second predetermined time multiplied by the fourth magnification. However, the stay time may be determined a little longer than the second predetermined time multiplied by the fourth predetermined magnification by taking into consideration that the moving course of the base island object is changed.

As in the latter, when the drift island object is separated from the base island object after the drift island object is moved so as to pass the base island object each other, a relative speed is the same as a case of only passing each other as shown in FIG. 10A because a portion that the base island object and the drift island object are moved to be separated from each other, i.e., in a portion of separation is similar to a case where drift island object is moved so as to pass the base island object each other. Therefore, the stay time is determined without correcting the second predetermined time. However, the stay time may be determined a little longer than the second predetermined time by taking into consideration that the moving course of the base island object is changed.

Although a detailed description is omitted, in FIG. 11B, in also a case where the base island object turns to the right or the left between the time t0 and the time t2, the stay time is determined by correcting the second predetermined time.

As described above, as for each of the left side course and the right side course, since a start point and an end point is determined on the basis of an origin the three-dimensional coordinates set in the first virtual space, that is, since a moving distance is determined in advance, the appearance object is moved by the moving distance determined in advance in the left side course or the right side course for the determined stay time. That is, the moving speed of the appearance object in the base island scene is calculated by dividing the moving distance by the stay time, and the appearance object is moved for each frame by a distance according to the moving speed. However, a frame is a unit time that updates a screen and may be set as 1/30 seconds or 1/60 seconds as an example.

The appearance object is moved from the start point to the end point of the determined moving course with the stay time, i.e., the determined moving speed. If the appearance object is moved to the end point, it is determined that an elimination condition on the appearance object is satisfied, and therefore, the image 130 of the appearance object is eliminated (or hidden).

Moreover, when a distance between the base island object and the drift island object corresponding to the appearance object for passing each other exceeds the approach range in the second virtual space, even before the appearance object for passing each other is moved to the end point of the moving route, that is, even if the elimination condition on the appearance object is not satisfied, in order to fit a positional relationship to the positional relationship between the base island object and the drift island object corresponding to the appearance island object for passing each other in the second virtual space, the image 130 of this appearance island object is eliminated in the game screen 100 of the base island scene. However, instead of eliminating the image 130 of the appearance object, the image 130 of the appearance object may be accelerated to be moved to the end point of the moving route. That is, a time until the image 130 of the appearance object is eliminated may be made shorter than the stay time as determined.

As described above, when the base island stage and the appearance object pass each other in the base island scene, the appearance object is moved on the moving route that is determined in advance, the positional relationship in the base island scene is not synchronized with the positional relationship in the marine chart scene, i.e., in the second virtual space; however, by determining the stay time, i.e., the moving speed of the appearance object in the base island scene based on the manner of approach and separation between the base island object and the drift island object corresponding to the appearance object for passing the base island object each other in the second virtual space, it is possible to make appear as if the same are synchronized. Therefore, the player does not feel uncomfortable even if the scene is changed between the base island scene and the marine chart scene.

As described above, in the second virtual space, the base island object and the plurality of drift island objects ride on the ocean currents to be moved according to the elapse of time basically. However, in a predetermined case, movement of the base island object and the drift island object is restricted.

In the embodiment, movement of the base island object and the drift island object may be stopped by stopping the time in the second virtual space. However, the movement speed of the base island object and the drift island object may be significantly reduced.

Moreover, in the embodiment, the predetermined case corresponds to a case where the appearance object discovered for the first time enters the passing-each-other range and a case where a predetermined event that has a priority over moving of the player object to the drift island object is being executed in the base island stage. Thus, as for the predetermined event that has a priority over the moving of the player object to the drift island object is to be executed, a program for executing this predetermined event includes processing that turns on an event priority flag 504j described later in starting the program and processing that turns off the event priority flag 504j in ending the program.

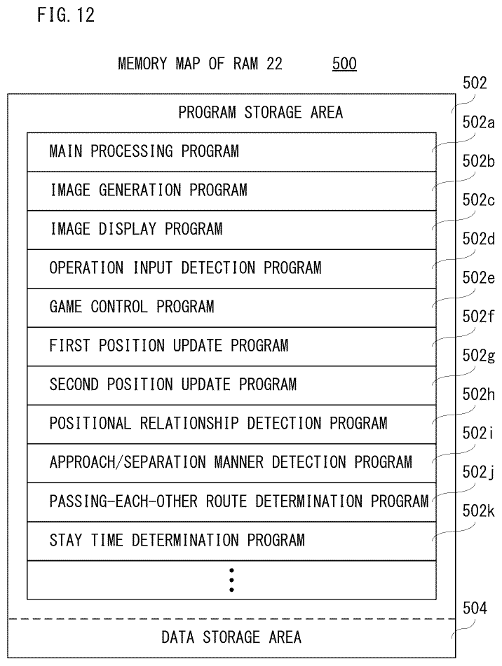

FIG. 12 is a view showing a non-limiting example memory map 500 of the RAM 22 of the game apparatus 10 shown in FIG. 2. As shown in FIG. 12, the RAM 22 includes a program storage area 502 and a data storage area 504. The program storage area 502 is stored with an application program of a virtual game (i.e., game program) according to this embodiment, which is an example of an information processing program. The game program includes a main processing program 502a, an image generation program 502b, an image display program 502c, an operation input detection program 502d, a game control program 502c, a first position update program 502f, a second position update program 502g, a positional relationship detection program 502h, an approach/separation manner detection program 502i, a passing-each-other route determination program 502j, a stay time determination program 502k, etc.

In addition, the information processing program may be stored in advance in the flash memory 24, or may be acquired from an external server or another game apparatus 10 via a network such as Internet. Moreover, the information processing program may be acquired from an external memory attachable to or detachable from the game apparatus 10, such an optical disk, a USB memory or a memory card. However, a part of the information processing program is stored in the flash memory 24, and other parts thereof may be acquired from the external server, other game apparatus 10 or the external memory. These also apply to the image generation data 504b described later.

The main processing program 502a is a program for processing a main routine of the game program of the embodiment. The image generation program 502b is a program for generating, using the image generation data 504b, game image data corresponding to various kinds of screens or images. The image display program 502c is a program for outputting the game image data generated according to the image generation program 502b to the display device 36. Therefore, various kinds of screens, such as the game screen 100 and the marine chart screen 200 are displayed on the display device 36.

The operation input detection program 502d is a program for detecting operation input data 504a with respect to an operation input portion by the player. In the embodiment, the operation input portion includes various kinds of push buttons, keys or switches provided on the input device 30.

The game control program 502e is a program for executing game control processing of the virtual game of the embodiment.

The first position update program 502f is a program for updating, in the first virtual space, positions (in the embodiment, three-dimensional positions) of various objects including the player object, the non-player objects such as the enemy object and the appearance object according to an operation input by the player or instructions of the computer, i.e., the processor 20.

The second position update program 502g is a program for updating, in the second virtual space, positions (in the embodiment, two-dimensional positions) of the base island object and respective drift island objects according to an operation input by the player or instructions of the processor 20. Moreover, the second position update program 502g is also a program for updating, in the second virtual space, a position (in the embodiment, two-dimensional position) of the designation image 220 according to an operation input by the player.

The positional relationship detection program 502h is a program for detecting a two-dimensional positional relationship between the base island object and each of the plurality of drift island objects or the drift island object corresponding to the appearance object for passing each other in the coordinate system of the second virtual space.

The approach/separation manner detection program 502i is a program for detecting, in the second virtual space, a manner that the base island object approaches the drift island object corresponding to the appearance object for passing each other and separated therefrom.

The passing-each-other route determination program 502j is a program for determining the moving route that the appearance object is moved as either the left side route or the right side route based on the positional relationship determined by the positional relationship detection program 502h when the base island stage and the appearance object pass each other in the base island scene.

The stay time determination program 502k is a program for determining the stay time based on the manner that the base island object approaches the drift island object corresponding to the appearance object for passing each other and separated therefrom detected by the approach/separation manner detection program 502i.

Although illustration is omitted, the program storage area 502 is stored with other programs, such as a communication program for communicating with the server or other game apparatuses 10, a sound output program for generating and outputting a sound required in the virtual game, a program for changing a direction of the virtual camera according to the operation input by the player, etc.

FIG. 13 is a view showing non-limiting example specific contents of the data storage area 504 of the RAM 22 shown in FIG. 12. As shown in FIG. 13, the data storage area 504 is stored with the operation input data 504a, the image generation data 504b, player object data 504c, drift island object data 504d, first virtual space position data 504e, passing-each-other route data 504f, marine chart data 504g, second virtual space position data 504h, a speed increase flag 504i, an event priority flag 50j, etc.

The operation input data 504a is data that is input from the input device 30, and is stored according to a time series. The operation input data 504a is eliminated if used for processing by the processor 20.

The image generation data 504b includes data for generating the data of various kinds of screens and the data of various kinds of objects, such as polygon data and texture data, etc.

The player object data 504c is data regarding the player object in the virtual game, and is updated by the game control processing. As an example, the player object data 504c is data regarding parameters, such as a three-dimensional position, the physical strength point, kinds of items being possessed and the number of items being possessed of the player object.

The drift island object data 504d is data regarding the drift island object and the drift island stage corresponding to this drift island object in the virtual game. As an example, the drift island object data 504d is data including respective pieces of information, first time flags and coupling flags of the respective drift island objects and respective the drift island stages corresponding the respective drift island objects.

The first time flag is flag data, for each appearance object, for determining whether each appearance object passes the base island stage each other is a first time. The first time flag is constituted by a register having a plurality of bits each of which corresponds to each of the plurality of appearance objects. Before the appearance object and the base island stage pass each other, the first time flag of this appearance object is turned on, and “1” is set to the bit corresponding to the appearance object. On the other hand, if the appearance object and the base island stage have passed each other once, the first time flag of this appearance object is turned off, and “0” is set to the bit corresponding to the appearance object.

The coupling flag is flag data, for each appearance object, for determining whether each appearance object is coupled to the base island stage. A coupling flag is a register having a plurality of bits each of which corresponds to each of the plurality of appearance objects. When the appearance object is coupled to the base island stage, the coupling flag of this appearance object is tuned on, and “1” is set to the bit corresponding to the appearance object. On the other hands, when the appearance object is not coupled to the base island stage, the coupling flag of this appearance object is tuned off, and “0” is set to the bit corresponding to the appearance object.

The first virtual space position data 504e is data indicating three-dimensional positions regarding respective non-player objects (including enemy object), the background objects and the drift island objects other than the player object in the first virtual space, i.e., the base island scene, the drift island scene or the coupled-island scene.

The passing-each-other route data 504f is data indicating three-dimensional positions of the start point and the end point of the left side route or the right side route determined according to the passing-each-other route determination program 502j.

The marine chart data 504g is data indicating, in the second virtual space, i.e., the world map, a sizes, a shape, a direction and a speed of each of the ocean currents, a position (in the embodiment, two-dimensional position) that the each ocean current is arranged, a two-dimensional position of each solid line arrow image 204 and a two-dimensional position of each dotted line full-line arrow image 206.

The second virtual space position data 504h is data indicating, in the second virtual space, i.e., the world map, two-dimensional positions regarding the base island object, the respective drift island objects and the designation image 220.

The speed increase flag 504i is flag data for determining whether the moving speed of the base island object is increased temporarily (i.e., first predetermined time), and is constituted by a one-bit register. When a speed increase condition is satisfied, the speed increase flag 504i is turned on, and “1” is set to the bit. When the speed increase condition is not satisfied and when the moving speed of the base island object is increased for the first predetermined time, the speed increase flag 504i is turned off, and “0” is set to the bit.

The event priority flag 504j is flag data for determining whether movement of the base island object and each drift island object should be stopped when the appearance object exists in the passing-each-other range, and is constituted by a one-bit register. When a priority is given to an event executed in the base island stage and the coupled-island stage and the movement of the base island object and each drift island object are to be stopped, the event priority flag 504j is turned on, and “1” is set to the bit. When a priority is not given to an event executed in the base island stage and the coupled-island stage and the movement of the base island object and each drift island object are not to be stopped and when the event is ended, the event priority flag 504j is turned off, and “0” is set to the bit.

Although illustration is omitted, the data storage area 504 is stored with other data required for the information processing of the virtual game, and is provided with a counter(s) or a timer(s). For example, data of a position and a direction of the virtual camera in each of the first virtual space and the second virtual space, etc. are also stored.

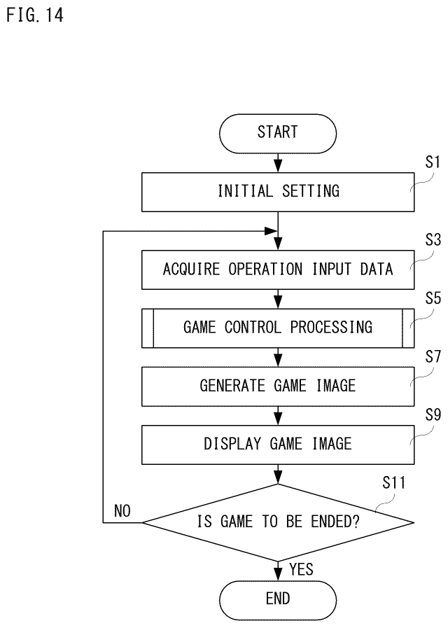

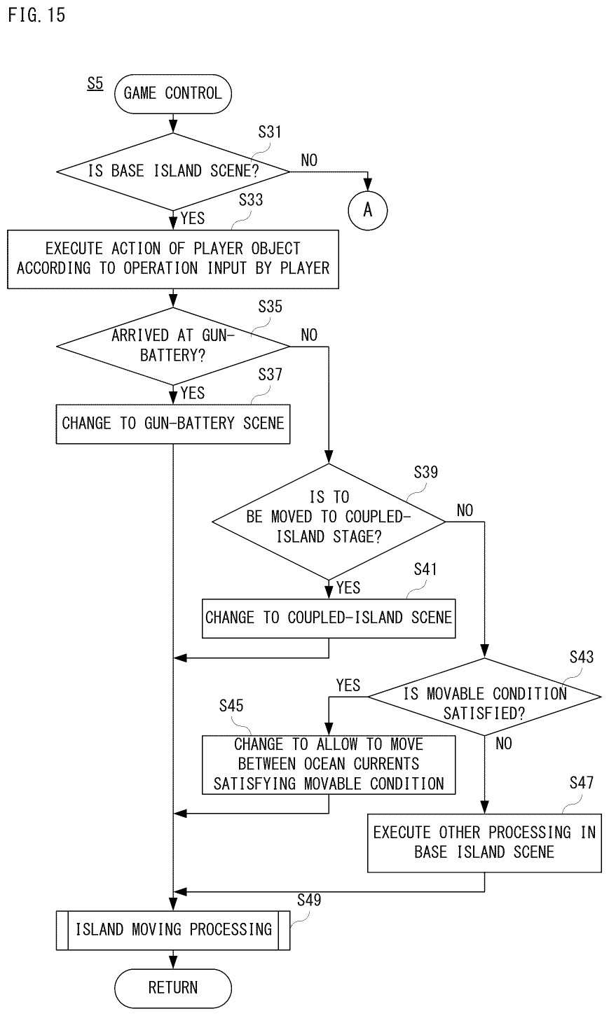

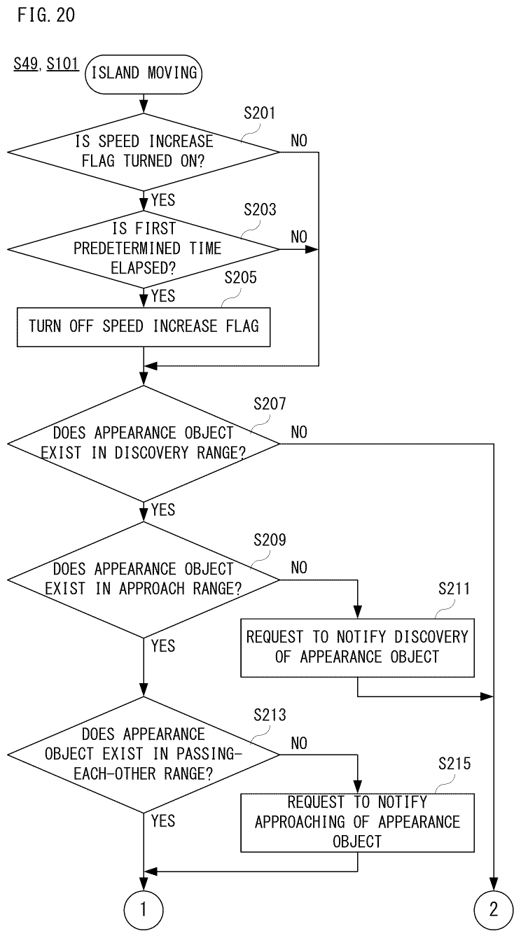

FIG. 14 is a flowchart showing non-limiting example processing of the game program (overall processing) by the processor 20 (or a computer) shown in FIG. 1. FIG. 15-FIG. 19 are flowcharts showing non-limiting example game control processing by the processor 20 shown in FIG. 1. FIG. 20-FIG. 22 are flowcharts showing non-limiting example island moving processing of the processor 20 shown in FIG. 1. In the following, the overall processing, the game control processing and the island moving processing will be described using FIG. 14-FIG. 22.

However, processing of respective steps of the flowcharts shown in FIG. 14-FIG. 22 are mere examples, and if the same or similar result is obtainable, an order of the respective steps may be exchanged. Moreover, in the embodiment, it will be described that the processing of the respective steps of the flowcharts shown in FIG. 14-FIG. 22 are basically executed by the processor 20; however, some steps may be executed by a processor(s) and/or a dedicated circuit(s) other than the processor 20.

When the power supply of the game apparatus 10 is turned on, prior to execution of the overall processing, the processor 20 executes a boot program stored in a boot ROM not shown, whereby respective units including the RAM 22, etc. are initialized. The game apparatus 10 will start the overall processing if execution of the game program according to the embodiment is instructed by the player.

As shown in FIG. 14, if the overall processing is started, the processor 20 executes initial setting in a step S1. Here, the processor 20 determines positions and directions in which the player object, respective non-player objects, respective background objects and the virtual camera to initial positions and initial directions in the base island scene.

Moreover, the processor 20 determines a shape, size and position of each of the ocean currents to the predetermined shape, size and position in the marine chart scene. Moreover, the processor 20 determines a position of the virtual camera in the marine chart scene to a predetermined position. Furthermore, the processor 20 determines positions regarding the base island object and the respective drift island objects to the initial positions in the marine chart scene. Furthermore, the processor 20 determines a position of the designation image 220 as the initial position in the marine chart scene.

However, when the virtual game is started from the continuation last time, the processor 20 determines the positions and the directions in which the player object, the respective non-player objects, the respective background objects and the virtual camera in the base island scene, the gun-battery scene, the drift island scene or the coupled-island scene are to be arranged to positions and directions at a time of saving. Moreover, when the virtual game is started from the continuation last time, the processor 20 determines the shapes, sizes and positions of the ocean currents in the marine chart scene to the shapes, sizes and positions at a time of saving. Moreover, the processor 20 determines the position of the virtual camera in the marine chart scene to the position at the time of saving. Further, the processor 20 determines the positions regarding the base island object and the respective drift island objects in the marine chart scene to the positions at the time of saving. Furthermore, the processor 20 determines the position of the designation image 220 in the marine chart scene to the position at the time of saving.

Therefore, the player object data 504c that the data of the initial position and the initial direction or the data of the position and the direction at the time of saving of the player object 102 are set to the current position data and current direction data is stored in the data storage area 504. Moreover, the data of the initial positions and the initial directions of the virtual camera in the base island scene, the gun-battery scene, the drift island scene or the coupled-island scene or the data of the position and the direction at the time of saving are set to the current position data and current direction data is stored in the data storage area 504.

In a subsequent step S3, the operation input data transmitted or input from the input device 30 is acquired, and in a step S5, the game control processing (see FIG. 15-FIG. 19) described later is executed. In a next step S7, the game image is generated.

In the step S7, the processor 20 generates, based on a result of the game control processing in the step S5, the game image data regarding the game screen of the base island scene, the gun-battery scene, the drift island scene or the coupled-island scene and/or the marine chart screen of the marine chart scene.

When generating the game image data regarding the game screens (100, etc.), the processor 20 arranges various kinds of objects in the first virtual space based on a result of the game control processing in the step S5, generates the base island scene, the gun-battery scene, the drift island scene or the coupled-island scene, and images by the virtual camera the base island scene, the gun-battery scene, the drift island scene or the coupled-island scene being generated. However, when displaying the image 120 of the marine chart in the game screen of the base island scene or the coupled-island scene, the processor 20 arranges various kinds of objects in the second virtual space based on the result of the game control processing in the step S5, generates the marine chart scene, generates the game image data that the generated marine chart scene is imaged by a further virtual camera, and reduces the generated game image data to output so that the reduced game image data is superposed on front of the game image data of the base island scene or the coupled-island scene.

Moreover, when generating the game image data regarding the marine chart screen 200, as described above, the processor 20 arranges various kinds of objects to the second virtual space based on the result of the game control processing of step S5 to generate the marine chart scene, and images the marine chart scene being generated with the further virtual camera.

In a next step S9, the game image is displayed. Here, the processor 20 outputs the game image data generated in the step S7 to the display device 36 through the display control circuit 32. However, when displaying the game screens (100, etc.) of the base island scene and the coupled-island scene, the image 120 of the marine chart is also displayed except for a case where the base island stage and the appearance object pass each other.

Then, in a step S11, it is determined whether the virtual game is to be ended. Determination in the step S11 is made on whether the player performs an instruction to end the virtual game, or the like. If “NO” is determined in the step S11, that is, if the virtual game is not to be ended, the process returns to the step S3. On the other hand, if “YES” is determined in the step S11, that is, if the virtual game is to be ended, the overall processing is terminated.

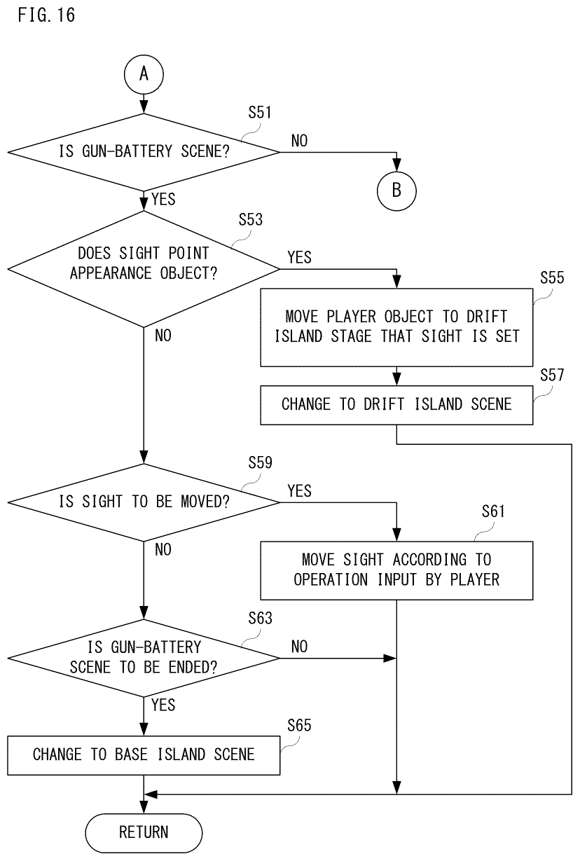

As shown in FIG. 15, if the game control processing is started, the processor 20 determines, in a step S31, whether it is the base island scene. If “NO” is determined in the step S31, that is, if it is not the base island scene, the process proceeds to a step S51 shown in FIG. 16. On the other hand, if “YES” is determined in the step S31, that is, if it is the base island scene, an action of the player object is executed according to the operation input of a player in step S33. At this time, when the player object is moved, the data of the three-dimensional position included in the player object data 504c is updated. However, when there is no operation input by the player, the processor 20 skips processing of the step S33.

In a next step S35, it is determined whether the player object arrives at a place where the gun-battery object is arranged. Here, the processor 20 determines, with reference to the player object data 504c, whether the three-dimensional position of the player object is within the second predetermined distance (e.g., one (1) meter in the first virtual space) from the three-dimensional position of the gun-battery object.

If “YES” is determined in the step S35, that is, if the player object arrives at the place where the gun-battery object is arranged, the scene is changed to the gun-battery scene in a step S37, and the process proceeds to a step S49. If processing of the step S37 is executed, when the process returns to an overall processing, the game image data of the game screen 100 of the gun-battery scene as shown in FIG. 4 is generated and outputted. A method of generating the game image data of the game screen 100 of the gun-battery scene is as described above.

On the other hand, if “NO” is determined in the step S35, that is, if the player object does not arrive at the place where the gun-battery object is arranged, it is determine, in a step S39, whether the player object is to be moved to the coupled-island stage. Here, the processor 20 determines whether the player object arrives at a junction port for moving to the coupled-island stage in the base island stage.

If “YES” is determined in the step S39, that is, the player object is to be moved to the coupled-island stage, in a step S41, the scene is changed to the coupled-island scene, and then, the process proceeds to the step S49. If processing of the step S41 is executed, when the process returns to the overall processing, the game image data of the game screen of the coupled-island scene is generated and output.

On the other hand, if “NO” is determined in the step S39, that is, if the player object is not to be moved to the coupled-island stage, it is determined, in a step S43, whether a movable condition is satisfied. If “YES” is determined in the step S43, that is, if the movable condition is satisfied, in a step S45, a space between the ocean currents that satisfy the movable condition is changed to be movable, and the process proceeds to the step S49. Here, in the marine chart data 504g, the processor 20 changes the space between the ocean currents to a movable state by changing the data of the dotted line arrow image 206 arranged between these ocean currents to the data of the solid line arrow image 204.

On the other hand, if “NO” is determined in the step S43, that is, if the movable condition is not satisfied, other processing on the base island scene is executed in a step S47, and the process proceeds to the step S49. In the step S47, the processor 20 generates a predetermined event or executes the predetermined event. When the predetermined event is executed, the event priority flag 504j may be turned on. The event priority flag 504j is turned off when the predetermined event is ended. Moreover, in the step S47, when satisfying a speed increase condition, the processor 20 turns on the speed increase flag 504i, and starts the count of the first predetermined time.

In the step S49, the island moving processing described later (see FIG. 20-FIG. 22) is executed, and the process returns to the overall processing shown in FIG. 14.

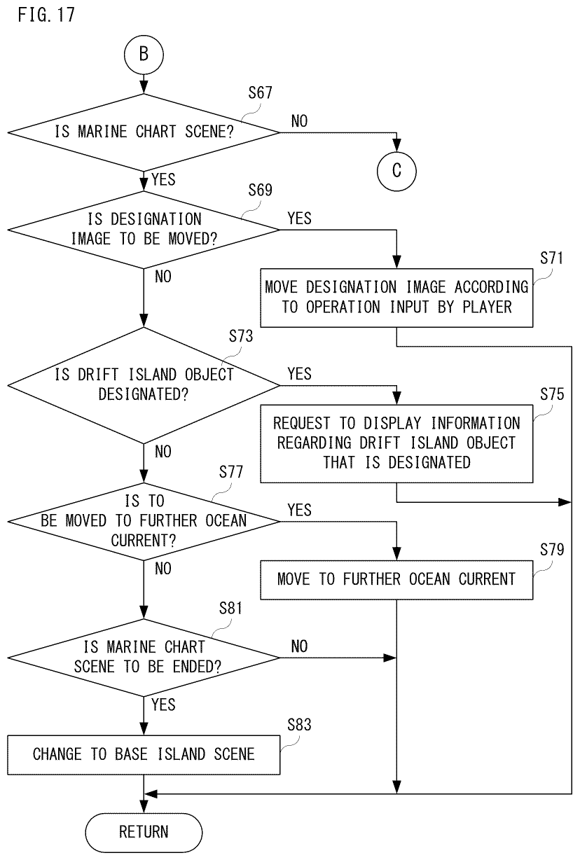

As shown in FIG. 16, it is determined whether it is the gun-battery scene in the step S51. If “NO” is determined in the step S51, that is, if it is not the gun-battery scene, the process proceeds to a step S67 shown in FIG. 17. On the other hand, if “YES” is determined in the step S51, that is, if it is the gun-battery scene, it is determined, in a step S53, whether the sight image 140 points the image 130 of the appearance object.

If “YES” is determined in the step S53, that is, if the sight image 140 points the image 130 of the appearance object, in the step S55, the player object is moved to the drift island stage corresponding to the image 130 of the appearance object that the sight image 140 points, and the scene is changed to the drift island scene in a step S57, and then, the process returns to the overall processing. If processing of the step S57 is executed, when the process returns to the overall processing, the game image data of the game screen of the drift island scene regarding the drift island stage corresponding to the image 130 of the appearance object pointed by the sight image 140 is generated and output.

However, in the drift island scene, the player object is arranged in a predetermined position of a predetermined field of the drift island stage. Moreover, since the player object cannot be moved when the drift island stage corresponding to the image 130 of the appearance object that the sight image 140 points is outside the movable range, the processing of the step S55 and the step S57 is skipped.

On the other hand, if “NO” is determined in the step S53, that is, if the sight image 140 does not point the image 130 of the appearance object, it is determined, in a step S59, whether the sight image 140 is to be moved. Here, the processor 20 determines whether an operation input by the player indicates an operation of the cross button.

If “YES” is determined in the step S59, that is, if the sight image 140 is to be moved, the sight image 140 is moved according to the operation input by the player in a step S61, and the process returns to the overall processing. In the embodiment, the direction of the virtual camera provided in the gun-battery scene (in the embodiment, the first virtual space) is changed in the step S61.

On the other hand, if “NO” is determined in the step S59, that is, if the sight image 140 is not to be moved, it is determined, in a step S63, whether the gun-battery scene is to be ended. Here, the processor 20 determines whether there is an instruction to end the gun-battery scene. For example, it is determined whether the B button is operated.

If “NO” is determined in the step S63, that is, if the gun-battery scene is not to be ended, the process returns to the overall processing. On the other hand, if “YES” is determined in the step S63, that is, if the gun-battery scene is to be ended, in a step S65, the scene is changed to the base island scene, and then, the process returns to the overall processing. If processing of the step S65 is executed, when the process returns to the overall processing, the game image data of the game screen 100 regarding the base island scene in a case where the player object is located on the base island stage near the place that the gun-battery object is arranged is generated and output.

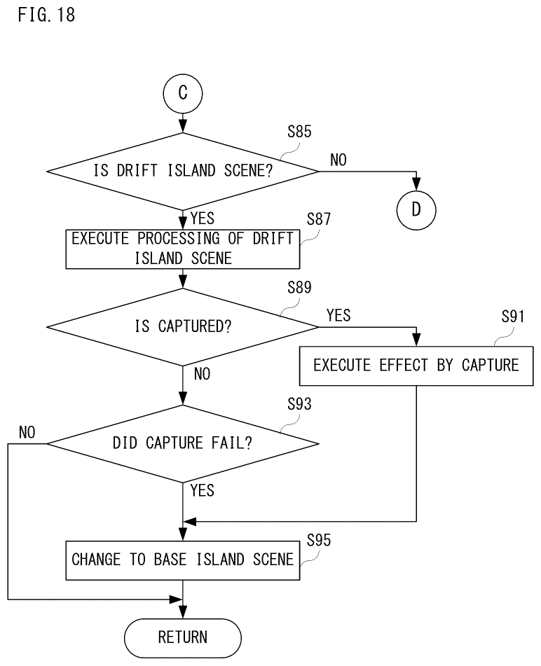

As shown in FIG. 17, in the step S67, it is determined whether it is the marine chart scene. If “NO” is determined in the step S67, that is, if it is not the marine chart scene, the process proceeds to a step S85 shown in FIG. 18. On the other hand, if “YES” is determined in the step S67, that is, if it is the marine chart scene, it is determined, in a step S69, whether the designation image 220 is to be moved. Here, the processor 20 determines whether an operation input by the player indicates an operation of the cross button.

If “YES” is determined in the step S69, that is, if the designation image 220 is to be moved, the designation image 220 is moved according to an operation input by the player in a step S71, and the process returns to the overall processing. In the step S71, the processor 20 updates the data of the two-dimensional position of the designation image 220 included in the second virtual space position data 504h. On the other hand, if “NO” is determined in the step S69, that is, if the designation image 220 is not to be moved, it is determined, in a step S73, whether the designation image 220 designates the image 212 of the drift island object.

If “YES” is determined in the step S73, that is, if the designation image 220 designates the image 212 of the drift island object, in a step S75, it is requested to display the information regarding the drift island object corresponding to the image 212 of the drift island object that is designated by the designation image 220, and then, the process returns to the overall processing. If processing of step S75 is executed, when the process returns to the overall processing, with reference to the drift island object data 504d, the game image data of the marine chart screen 200 that the information on the drift island object corresponding to the image 212 of the drift island object designated by the designation image 220 is indicated is generated and output.

On the other hand, if “NO” is determined in the step S73, that is, if the designation image 220 does not designate the image 212 of the drift island object, it is determined, in a step S77, whether the base island object is to be moved to a further ocean current. Here, the processor 20 determines whether an operation input by the player is a moving instruction to the further ocean current.

If “YES” is determined in the step S77, that is, if the base island object is to be moved to the further ocean current, in a step S79, the base island object is moved to the further ocean current that is instructed to be moved, and then, the process returns to the overall processing. However, even if there is a moving instruction to the further ocean current, when the base island object is not arranged in the position where the solid line arrow image 204 is being displayed, processing of the step S79 is skipped.

On the other hand, if “NO” is determined in the step S77, that is, if the base island object is not to be moved to the further ocean current, it is determined, in a step 81, whether the marine chart scene is to be ended. Here, the processor 20 determines whether an operation input by the player indicates to end the marine chart scene or to return to the base island scene.

If “NO” is determined in the step S81, that is, if the marine chart scene is not to be ended, the process returns to the overall processing. On the other hand, if “YES” is determined in the step S81, that is, if the marine chart scene is to be ended, in a step S83, the scene is changed to the base island scene, and then, the process returns to the overall processing. If processing of the step S83 is executed, when the process returns to the overall processing, the game image data of the game screen of the base island scene is generated and output.

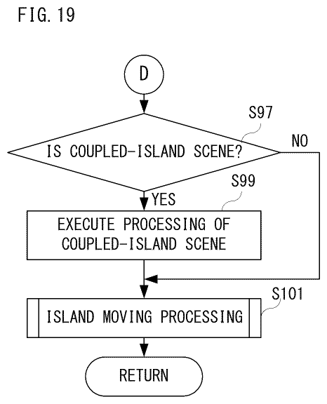

As shown in FIG. 18, in the step S85, it is determined whether it is the drift island scene. If “NO” is determined in the step S85, that is, if it is not the drift island scene, the process proceeds to a step S97 shown in FIG. 19. On the other hand, if “YES” is determined in the step S85, that is, if it is the drift island scene, processing of the drift island scene is executed in a step S87. Here, according to an operation input by the player, the processor 20 moves the player object, or generates or executes a predetermined event set to the drift island object. When the predetermined event is executed, the event priority flag 504j may be turned on. The event priority flag 504j is turned off when the predetermined event is ended. Moreover, in the step S87, when satisfying the speed increase condition, the processor 20 turns on the speed increase flag 504i, and starts the count of the first predetermined time.

In a next step S89, it is determined whether the drift island stage is captured. If “YES” is determined in the step S89, that is, if the drift island stage is captured, an effect by capture is executed in a step S91, and the process proceeds to a step S95. In the step S91, the predetermined effect set to the captured drift island stage is executed, such as coupling the captured drift island stage to the base island stage, acquiring a predetermined item, appearance of a new drift island stage. When the captured drift island stage is coupled to the base island stage, in the coupling flag included in the drift island object data 504d, “1” is set to the bit corresponding to this drift island stage. Moreover, when the predetermined item is acquired, the data of the kind and the number of possessed items included in the player object data 504c is updated.

On the other hand, if “NO” is determined in the step S89, that is, if the drift island stage is not captured, it is determined, in a step S93, whether capture of the drift island stage is failed. If “NO” is determined in the step S93, that is, if capture of the drift island stage is not failed, the process returns to the overall processing. On the other hand, if “YES” is determined in the step S93, that is, if capture of the drift island stage is failed, the process proceeds to a step S95.

In the step S95, the scene is changed to the base island scene, and the process returns to the overall processing. At this time, the player object is returned to the predetermined position of the base island stage. If processing of step S95 is executed, when the process returns to the overall processing, the game image data of the game screen of the base island scene is generated and output.

As shown in FIG. 19, in a step S97, it is determined whether it is the coupled-island scene. If “NO” is determined in the step S97, that is, if it is not the coupled-island scene, the island moving processing is executed, and the process returns to the overall processing. Although illustration is omitted, if “NO” is determined in the step S97, in the virtual game, a movie may be played, which describes a story or a particular non-player object.

On the other hand, if “YES” is determined in the step S97, that is, if it is the coupled-island scene, processing of the coupled-island scene is executed in a step S99, and the process proceeds to a step S101. In the step S99, according to the operation input of a player, the processor 20 moves the player object, or generates or executes a predetermined event set to the coupled-island stage. Therefore, when returning to the base island stage, in the step S99, the scene is changed to the base island scene. Moreover, when executing the predetermined event, the event priority flag 504j may be turned on. The event priority flag 504j is turned off when the predetermined event is ended. Moreover, in the step S99, when satisfying the speed increase condition, the processor 20 turns on the speed increase flag 504i, and starts the count of the first predetermined time.

FIG. 20-FIG. 22 are flowcharts showing non-limiting example island moving processing of the step S49 shown in FIG. 15 and a step S101 shown in FIG. 19. As shown in FIG. 20, if the island moving processing is started, the processor 20 determines, in a step S201, whether the speed increase flag 504i is turned on.

If “NO” is determined in the step S201, that is, if the speed increase flag 504i is turned off, the process proceeds to a step S207. On the other hand, if “YES” is determined in the step S201, that is, if the speed increase flag 504i is turned on, it is determined, in a step S203, whether the first predetermined time, i.e., a time that the moving speed of the base island object is to be increased temporarily elapses.

If “YES” is determined in the step S203, that is, if the first predetermined time elapses, the speed increase flag 504i is turned off in a step S205, and the process proceeds to the step S207. On the other hand, if “NO” is determined in the step S203 that is, if the first predetermined time does not elapse, the process proceeds to the step S207.

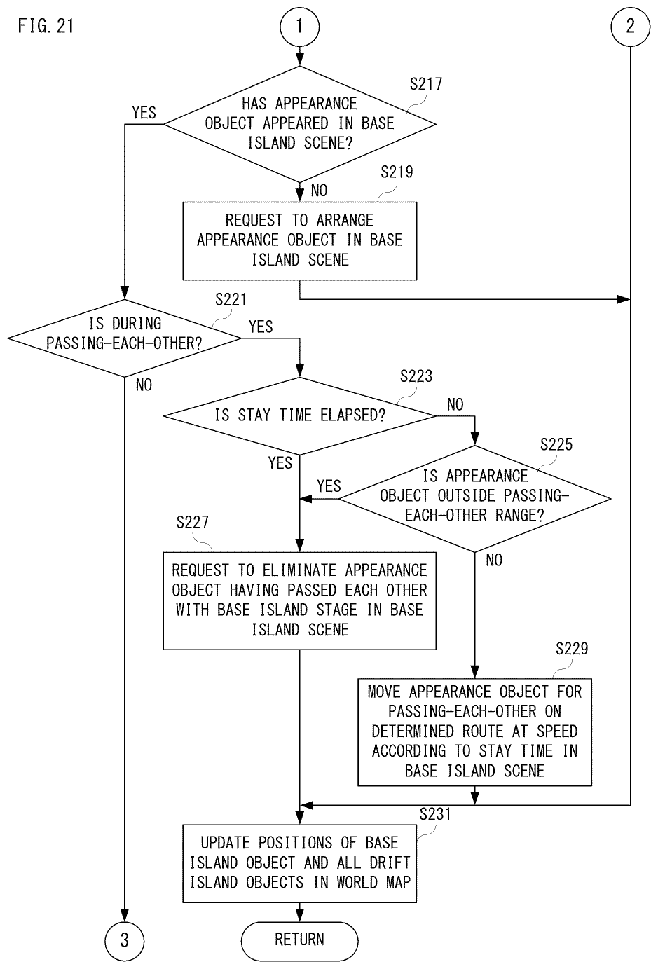

In the step S207, it is determined whether the appearance object exists within the discovery range. Here, the processor 20 determines, with reference to the second virtual space position data 504h, whether there is an appearance object that the distance with the base island stage is within the radius R1. If “NO” is determined in the step S207, that is, if there is no appearance object within the discovery range, the process proceeds to a step S231 shown in FIG. 21.

On the other hand, if “YES” is determined in the step S207, that is, if an appearance object exists within the discovery range, it is determined, in a step 209, whether that appearance object exists within the approach range. Here, the processor 20 determines, with reference to the second virtual space position data 504h, whether the distance between the base island stage and the appearance object existing in the discovery range is within the distance of the radius R2. When there are a plurality of appearance objects within the discovery range, it is determined whether each of the appearance objects exists within the approach range.

If “NO” is determined in the step S209, that is, if no appearance object exists within the approach range, in a step S211, it is requested to notify the information of a discovery of the appearance object, and the process proceeds to a step S231. If processing of the step S211 is executed, when the process returns to the overall processing, in the base island scene or the coupled-island scene, the game image data that notifies having discovered the appearance object is generated and output.

On the other hand, if “YES” is determined in the step S209, that is, if the appearance object exists within the approach range, it is determined, in a step S213, whether the appearance object exists the passing-each-other range. Here, the processor 20 determines, with reference to the second virtual space position data 504h, whether the distance between the base island stage and the appearance object existing within the approach range is within the distance of the radius R3. When there are a plurality of appearance objects within the approach range, it is determined whether each of the appearance objects exists within the passing-each-other range.

If “YES” is determined in the step S213, that is, it the appearance object exists within the passing-each-other range, the process proceeds to a step S217 shown in FIG. 21. On the other hand, if “NO” is determined in the step S213, that is, if the appearance object does not exist within the passing-each-other range, it is requested to notify that the appearance object is approaching in a step S215, and the process proceeds to the step S217. If processing of step S215 is executed, when the process returns to the overall processing, in the base island scene or the coupled-island scene, the game image data that notifies that the appearance object is approaching is generated and output.

As shown in FIG. 21, in the step S217, it is determined whether the appearance object has already occurred in the base island scene. If “YES” is determined in the step S217, that is, if the appearance object has already occurred in the base island scene, the process proceeds to a step S221. On the other hand, if “NO” is determined in the step S217, that is, if the appearance object has not occurred in the base island scene, in a step S219, it is requested to arrange the appearance object in the base island scene, and then, the process proceeds to the step S231. If processing of the step S219 is executed, when the process returns to the overall processing, in the base island scene, the appearance object is arranged in the position away by the first predetermined distance from the base island stage, and the game image data including the image 130 of the appearance object is generated and output.

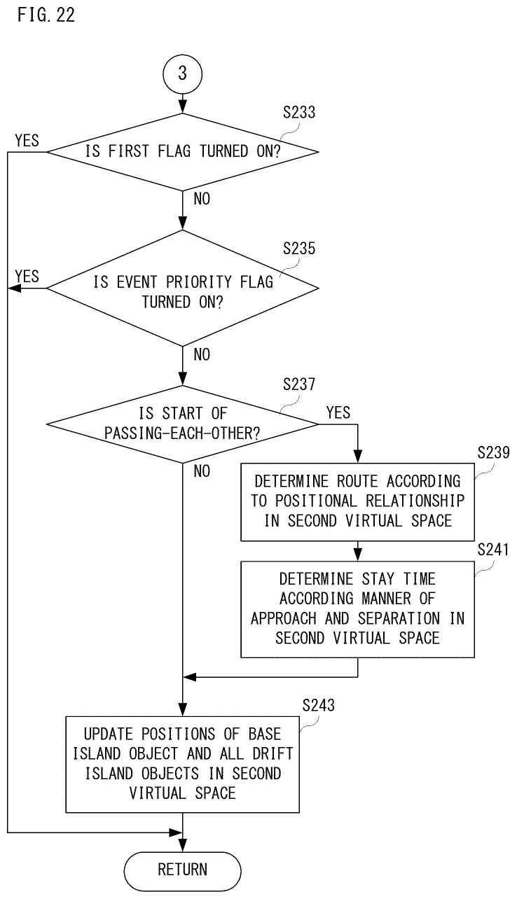

In the step S221, it is determined whether it is during when the base island stage and the appearance object are passing each other. If “NO” is determined in the step S221, that is, if it is not during when the base island stage and the appearance object are passing each other, the process proceeds to a step S233 shown in FIG. 22.

On the other hand, if “YES” is determined in the step S221, that is, if it is during when the base island stage and the appearance object are passing each other, it is determined, in the step S223, whether the stay time elapses in the step S233.

If “YES” is determined in the step S223, that is, if the stay time elapses, in a step S227, in the base island scene, it is requested to eliminate the appearance object having passed each other, and the process proceeds to the step S231. If processing of step S227 is executed, when the process returns to the overall processing, in the base island scene, the appearance object having passed each other is eliminated, and the game image data that the image 130 of the appearance object having passed each other is eliminated is generated and output.

On the other hand, if “NO” is determined in the step S223, that is, if the stay time does not elapse, in a step S225, it is determine whether the appearance object exists outside the passing-each-other range. If “YES” is determined in the step S225, that is, if the appearance object exists outside the passing-each-other range, the process proceeds to the step S227.

On the other hand, if “NO” is determined in the step S225, that is, if the appearance object exists within the passing-each-other range, in a step S229, in the base island scene, the appearance object for passing each other is made to be moved on determined the left side route or determined the right side route at a speed according to the stay time, and then, the process proceeds to the step S231.

In the step S231, the positions of the base island object and all the drift island objects in the second virtual space are updated, and the process returns to the overall processing. The positions of the base island object and all the drift island objects are updated according to the directions and the speeds of the ocean currents on which the base island object and all the drift island objects ride now, respectively. That is, the data of the two-dimensional positions of the base island object and all the drift island objects included in the second space position data 504h are updated. However, when the speed increase flag 504i is turned on, the position of the base island object is updated according to the speed that is increased than the speed of the ocean current by the predetermined speed. These apply to a step S243 described later.

As shown in FIG. 22, in the step S233, it is determined whether the first time flag regarding the appearance object for passing each other is turned on. If “YES” is determined in the step S233, that is, if the first time flag is turned on, the process returns to the overall processing. That is, since the processor 20 does not execute processing in the step S243 is not executed when the first time flag is turned on, the base island object and all the drift island objects in the second virtual space are in a stopped state.

On the other hand, if “NO” is determined in the step S233, that is, if the first time flag is turned off, it is determined, in a step S235, whether the event priority flag 504j is turned on. If “YES” is determined in the step S235, that is, if the event priority flag 504j is turned on, the process returns to the overall processing. That is, since the processor 20 does not execute the processing of the step S243 when the event priority flag 504j is turned on even if a first time flag is turned off, the base island object and all the drift island objects in the second virtual space are in a stopped state.

On the other hand, if “NO” is determined in the step S235, that is, if the event priority flag 504j is turned off, it is determined, in a step S237, whether it is a start of passing-each-other of the base island stage and the appearance object. Here, when the current frame is a next frame of a frame that the appearance object is arranged, the processor 20 determines that in the base island scene, it is the start of the passing-each-other of the base island stage and the appearance object.

If “NO” is determined in the step S237, that is, if it is not the start of the passing-each-other of the base island stage and the appearance object, the process proceeds to the step S243. On the other hand, if “YES” is determined in the step S237, that is, if it is the start of the passing-each-other of the base island stage and the appearance object, in a step S239, the moving route is determined according to the positional relationship between the base island object corresponding to the base island stage and the drift island object corresponding to the appearance object for passing each other in the second virtual space, and in a step S241, the stay time is determined according to the manner of approach and separation of the base island object and the drift island object corresponding to the appearance object for passing each other in the second virtual space, and then, the process proceeds to the step S243. The determination method of the stay time is as described using the FIG. 10A-FIG. 10C, FIG. 11A, FIG. 11B, etc.

In the step S243, the positions of the base island object and all the drift island objects in the second virtual space are updated, and the process returns to the overall processing.

According to the embodiment, an arbitrary event such a battle in the base island object generated in the first virtual space is executed while the base island object is moved in the world map generated in the second virtual space, it is possible to execute an event in a virtual space different from the world map while moving in the world map.

In addition, although the images of all the ocean currents and the images of all the drift island objects are displayed visibly in the image of the marine chart and the marine chart screen in the embodiment, it is possible to make these images visible as the virtual game progresses or when entering the discovery range. It is possible to make the image of the ocean current and the image of the drift island object invisible by displaying an image covering the image of the ocean current and the image of the drift island object or by make the image of the ocean current and the image of the drift island object be hidden.

Moreover, in the embodiment, the overall processing of the virtual game, the game control processing and the island moving processing shown in FIG. 14-FIG. 22 are all executed by the processor of the game apparatus; however, a part or all of them may be executed by an external computer capable of communicating with this game apparatus so that the game apparatus may acquire from the computer a result(s) of the processing in part or all. In such a case, a network game system or an information processing system is constituted by the game apparatus and the external computer that is communicably connected with the game apparatus.

Moreover, the structure, various kinds of screens and specific numeral values shown in the embodiment are mere examples, should not be limited and can be appropriately changed according to actual products.

Moreover, if the same or similar result is obtainable, an order of the respective steps shown in the flowcharts may be exchanged.

Although certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What is claimed is:

1. A non-transitory computer-readable storage medium having stored with an information processing program executable by a computer of an information processing apparatus, wherein the information processing program causes one or more processors of the computer to execute:
controlling, based on an operation input by a user, a character object associated with the user in a first virtual space;
arranging a first object and a second object in a second virtual space different from the first virtual space;
moving the first object automatically as elapse of time in the second virtual space;
arranging a third object corresponding to the second object in the first virtual space when a first positional condition related to positions of the first object and the second object in the second virtual space is satisfied; and
executing an event related to the third object if an event generation condition related to the third object is satisfied when the third object is arranged in the first virtual space.

2. The storage medium according to the claim 1, wherein the information processing program causes one or more processors of the computer to execute moving the second object automatically as elapse of time.

3. The storage medium according to the claim 1, wherein the information processing program causes one or more processors of the computer to execute moving the first object on a predetermined moving route in the second virtual space.

4. The storage medium according to the claim 3, wherein the information processing program causes one or more processors of the computer to execute:
setting a plurality of predetermined moving routes; and
moving the first object on one predetermined moving route out of the plurality of predetermined moving routes.

5. The storage medium according to the claim 4, wherein the information processing program causes one or more processors of the computer to execute moving the first object from the predetermined moving route on which the first object is currently moving to a further predetermined moving route out of the plurality of predetermined moving routes.

6. The storage medium according to the claim 3, wherein the information processing program causes one or more processors of the computer to execute:
setting the plurality of predetermined moving routes each of which is an annular shape; and
moving the second object on one predetermined moving route out of the plurality of predetermined moving routes.

7. The storage medium according to the claim 1, wherein the information processing program causes one or more processors of the computer to execute changing a moving speed of the first object when a speed change condition is satisfied.

8. The storage medium according to the claim 1, wherein the information processing program causes one or more processors of the computer to execute moving the first object automatically regardless of an operation by the user.

9. The storage medium according to the claim 1, wherein the information processing program causes one or more processors of the computer to execute restricting a movement of the first object while a priority event is executed in the first virtual space.

10. The storage medium according to the claim 1, wherein the information processing program causes one or more processors of the computer to execute moving the third object automatically in the first virtual space.

11. The storage medium according to the claim 10, wherein the information processing program causes one or more processors of the computer to execute moving the third object, when the third object and a fourth object corresponding to the first object pass each other in the first virtual space, on a right side or a left side of the fourth object according to a positional relationship between the first object and the second object in the second virtual space.

12. The storage medium according to the claim 10, wherein the information processing program causes one or more processors of the computer to execute moving the third object in the first virtual space regardless of a position of the second object in the second virtual space.

13. The storage medium according to the claim 12, wherein the information processing program causes one or more processors of the computer to execute determining a moving speed of the third object according to a positional relationship between the first object and the second object in the second virtual space.

14. The storage medium according to the claim 1, wherein the information processing program causes one or more processors of the computer to execute performing, when arranging the third object in the first virtual space, a notification related to an arrangement of the third object.

15. The storage medium according to the claim 1, wherein the information processing program causes one or more processors of the computer to execute eliminating the third object from the first virtual space when an elimination condition related to the third object is satisfied.

16. The storage medium according to the claim 15, wherein the information processing program causes one or more processors of the computer to execute eliminating the third object from the first virtual space even if the elimination condition is not satisfied when a positional relationship between the first object and the second object in the second virtual space satisfies a second positional condition.

17. The storage medium according to the claim 1, wherein the information processing program causes one or more processors of the computer to execute arranging the third object in a predetermined position in the first virtual space regardless of a positional relationship between the first object and the second object in the second virtual space.

18. An information processing system comprising one or more processors, wherein the information processing system causes the one or more processors to execute:
controlling, based on an operation input by a user, a character object associated with the user in a first virtual space;
arranging a first object and a second object in a second virtual space different from the first virtual space;
moving the first object automatically as elapse of time in the second virtual space;
arranging a third object corresponding to the second object in the first virtual space when a first positional condition related to positions of the first object and the second object in the second virtual space is satisfied; and
executing an event related to the third object if an event generation condition related to the third object is satisfied when the third object is arranged in the first virtual space.

19. An information processing apparatus comprising one or more processors, wherein the information processing apparatus causes the one or more processors to execute:
controlling, based on an operation input by a user, a character object associated with the user in a first virtual space;
arranging a first object and a second object in a second virtual space different from the first virtual space;
moving the first object automatically as elapse of time in the second virtual space;
arranging a third object corresponding to the second object in the first virtual space when a first positional condition related to positions of the first object and the second object in the second virtual space is satisfied; and
executing an event related to the third object if an event generation condition related to the third object is satisfied when the third object is arranged in the first virtual space.

20. An information processing method of an information processing apparatus comprising one or more processors, wherein the information processing apparatus causes one or more processors to execute:
controlling, based on an operation input by a user, a character object associated with the user in a first virtual space;
arranging a first object and a second object in a second virtual space different from the first virtual space;
moving the first object automatically as elapse of time in the second virtual space;
arranging a third object corresponding to the second object in the first virtual space when a first positional condition related to positions of the first object and the second object in the second virtual space is satisfied; and
executing an event related to the third object if an event generation condition related to the third object is satisfied when the third object is arranged in the first virtual space.
